(19) United States
(12) Patent Application Publication
(10) Pub. No.: US 2002/0077954 A1
(43) Pub. Date: Jun. 20, 2002

(54) Sourcing system and method

(76) Inventors: Thomas H. Slaight, Scarsdale, NY (US); Alan R. Norman, Aurora (CA); Phillip W. King IV, Toronto (CA); Niul A. Burton, Alamo, CA (US)

Correspondence Address: David G. Wille, Suite 600, 2001 Ross Avenue, Dallas, TX, 75201-2980, US

(21) Appl. No.: 09/737,697

(22) Filed: Dec. 14, 2000

Related U.S. Application Data
(60) Provisional application No. 60/173,573, filed on Dec. 29, 1999.

(51) Int. Cl. G06F 17/60

(52) U.S. Cl. 705/37

(57) ABSTRACT

One aspect of the invention is an electronic auction system. The electronic auction system comprises computer software that is operable to receive multiple parameter bids on at least one product from a plurality of vendors. The software is further operable to calculate the total cost of the product to the purchaser in response to each vendor's bid according to a total cost formula.

### BACKGROUND OF THE INVENTION

Corporations, businesses, organizations, governmental agencies and other entities regularly purchase a variety of office, industrial, manufacturing, computer, communication and other products, systems, goods, supplies, equipment and services (individually and collectively referred to herein for brevity as “products”). The process for awarding contracts for such purchases is often lengthy and expensive. Transactions are sometimes complicated by discount, delivery, installation, training, maintenance, warranty and other important variables which are often negotiated before the transaction is finalized. Purchasers typically conduct negotiations with different vendors to obtain the best products for the best price.

Some entities purchasing such products establish in-house purchasing departments or out-source the purchasing responsibilities to consultants. These purchasing specialists employ well established procedures for obtaining product specifications, pricing and other important information from the vendors and comparing the products offered by vendors. These procedures may include using conventional tools such a request for information (“RFI”) and a request for proposal (“RFP”).

More recently, certain entities have implemented online auctions to facilitate the purchase of certain types of products. Existing auction systems generally focus on price of a product as determining the outcome of the auction, rather than the total cost including price plus the other costs incurred in using, operating, or otherwise incurred in the ownership or disposal of the products to the purchaser.

### SUMMARY OF THE INVENTION

One aspect of the invention is an electronic auction system. The electronic auction system comprises computer software that is operable to receive multiple parameter bids on at least one product from a plurality of vendors. The software is further operable to calculate the total cost of the product to the purchaser in response to each vendor's bid according to a total cost formula. Other aspects of the invention will be described below.

The invention has several important technical advantages. Various embodiments of the invention may have some, none, or all of these advantages. The invention allows an entity to purchase products using an auction process that takes into account a variety of variables of interest to the purchaser other than price. Other parameters that may be factored into a total cost for a particular product may include, but are not limited to, discount, delivery, installation, training, maintenance, switching costs, and warranties. The invention thus allows a purchaser to efficiently take multiple parameters into account when making a purchase so as to obtain a more desirable outcome when purchasing products. The invention may also facilitate competition in bidding by optionally providing feedback to suppliers during the bidding process. In some instances, a purchaser may wish to adjust the total cost formula during the auction to test different weighting of various factors.

### BRIEF DESCRIPTION OF THE DRAWINGS

For a more complete understanding of the present invention and the advantages thereof, reference is now made to the following descriptions taken in conjunction with the accompanying drawings in which:

FIG. 1 is a flow diagram of an example sourcing method;

FIG. 2 is a flow diagram of an example auction planning process;

FIG. 3 is a flow diagram of an example RFI and RFP development, review and issue process;

FIG. 4 is a flow diagram of an example auction execution process;

FIG. 5 is a flow diagram one example of an auction set up process that may be used in accordance with the invention;

FIG. 6 is an illustration of an example master table search, selection and creation interface accessible by the implementor;

FIG. 7 is an illustration of an example user master information input interface accessible by the implementor;

FIG. 8 is an illustration of an example product or category master information input interface accessible by the implementor;

FIG. 9 is an illustration of an example sub-product or sub-category master input information interface accessible by the implementor;

FIG. 10 is an illustration of an example parameter master information input interface accessible by the implementor;

FIG. 11 is an illustration of an example constants master information input interface accessible by the implementor;

FIG. 12 is an illustration of an example auction search, selection and creation interface accessible by the implementor;

FIGS. 12B and 12C are illustrations of an example auction identification and scheduling interface accessible by the implementor;

FIG. 13 is an illustration of an example category assignment interface accessible by the implementor;

FIG. 14 is an illustration of an example vendor assignment interface accessible by the implementor;

FIG. 15 is an illustration of an example subcategory assignment interface accessible by the implementor;

FIGS. 16A and 16B are illustrations of an example parameter setup interface accessible by the implementor;

FIG. 17 is an illustration of an example constant assignment and setup for calculating total costs interface accessible by the implementor;

FIG. 18 is an illustration of an example subcategory assignment interface accessible by the implementor;

FIGS. 19A and 19B are illustrations of an example formula to parameter assignment interface accessible by the implementor;

FIGS. 20A, 20B and 20C are illustrations of examples of total cost formulas for telemarketing services, printers and office supplies, respectively;

FIGS. 21A and 21B are illustrations of an example report assignment interface accessible by the implementor;

FIGS. 22A and 22B are illustrations of an example auction verification and notification interface accessible by the implementor;

FIG. 23 is an illustration of an example auction management interface accessible by the implementor;

FIG. 23A is an illustration of an example purchase accessible interface which enables the purchaser to view the total cost formula;

FIG. 24 is an illustration of an example auction activity viewing interface accessible by the implementor and the purchaser;

FIGS. 25A and 25B are illustrations of an example vendor accessible interface which enables the vendor to enter the vendor's bids for the multiple parameters during the auction and select other features provided to the vendor by the system;

FIG. 26 is an illustration of an example purchaser accessible interface which enables the purchaser to view bids entered by the vendors on the multiple parameters, make adjustments thereto during the auction and select other features provided to the purchaser by the system;

FIG. 27 is an illustration of an example purchaser accessible interface for displaying bid activity to the purchaser during the auction;

FIG. 28 is an illustration of an example interface having an example of a stock graph displaying bid activity;

FIG. 29 is an illustration of an example savings graph;

FIG. 30 is an illustration of an example alternative savings graph;

FIG. 31 is an illustration of an example alternative savings graph;

FIG. 32 is an illustration of an example interface having a vendor pricing feedback graph;

FIG. 33 is an illustration of an example interface having an alternative vendor pricing feedback graph;

FIG. 34 is an illustration of an example interface having an alternative vendor pricing feedback graph;

FIG. 35 is an illustration of an example interface having an alternative vendor pricing feedback graph;

FIG. 36 is a schematic diagram of an example architecture of software for implementing the system and method of the present invention; and

FIG. 37 is a schematic diagram of an example physical network for implementing the system and method of the present invention.

### DETAILED DESCRIPTION OF THE INVENTION

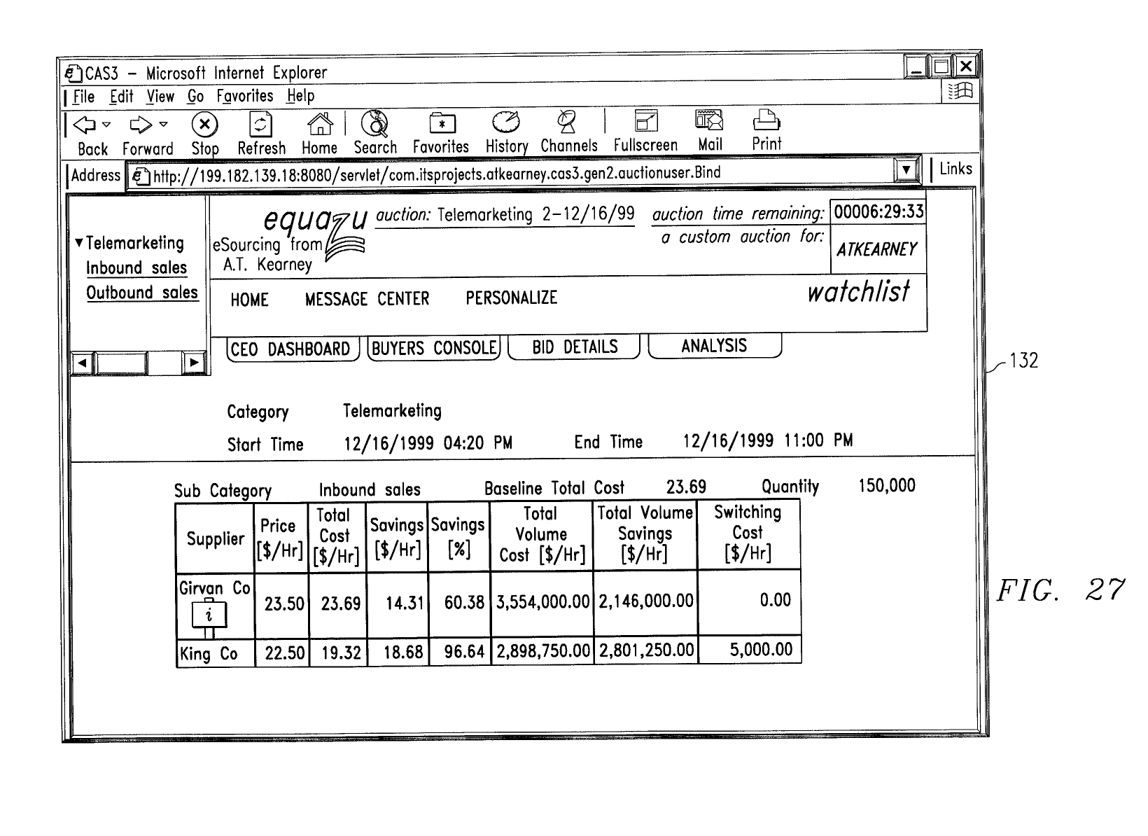

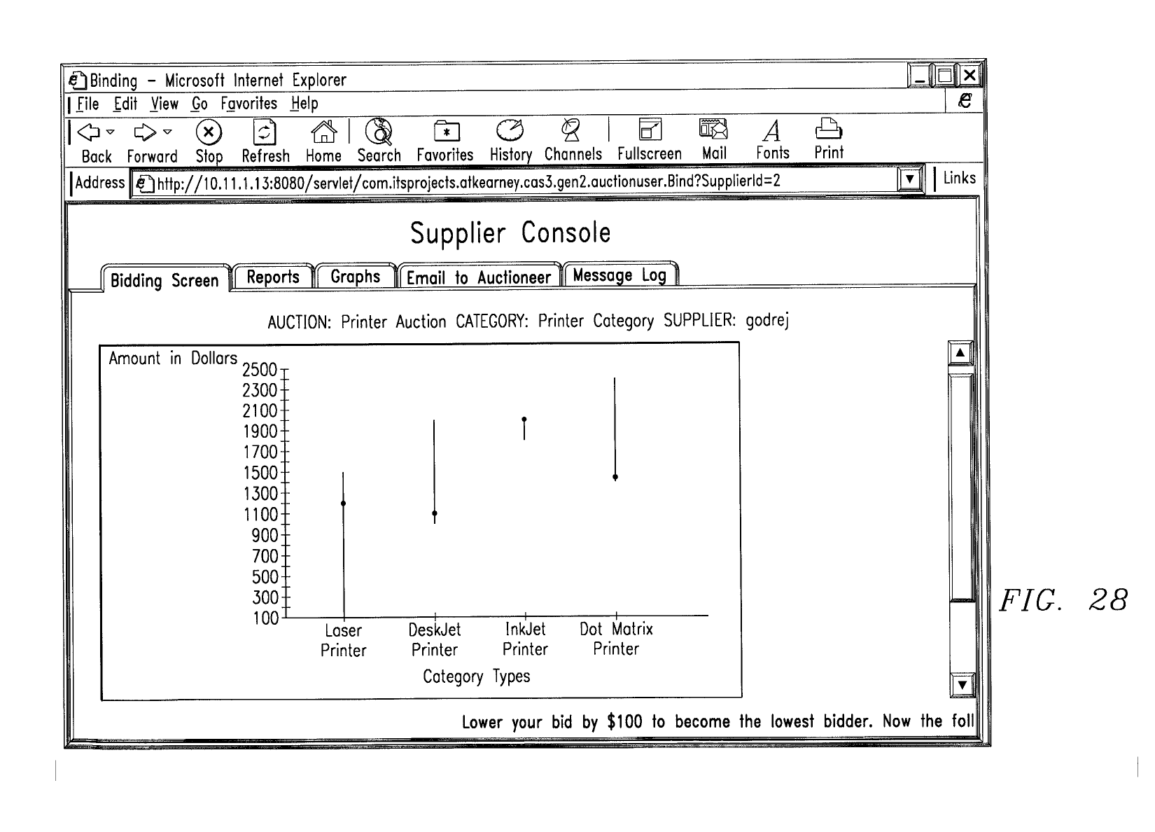

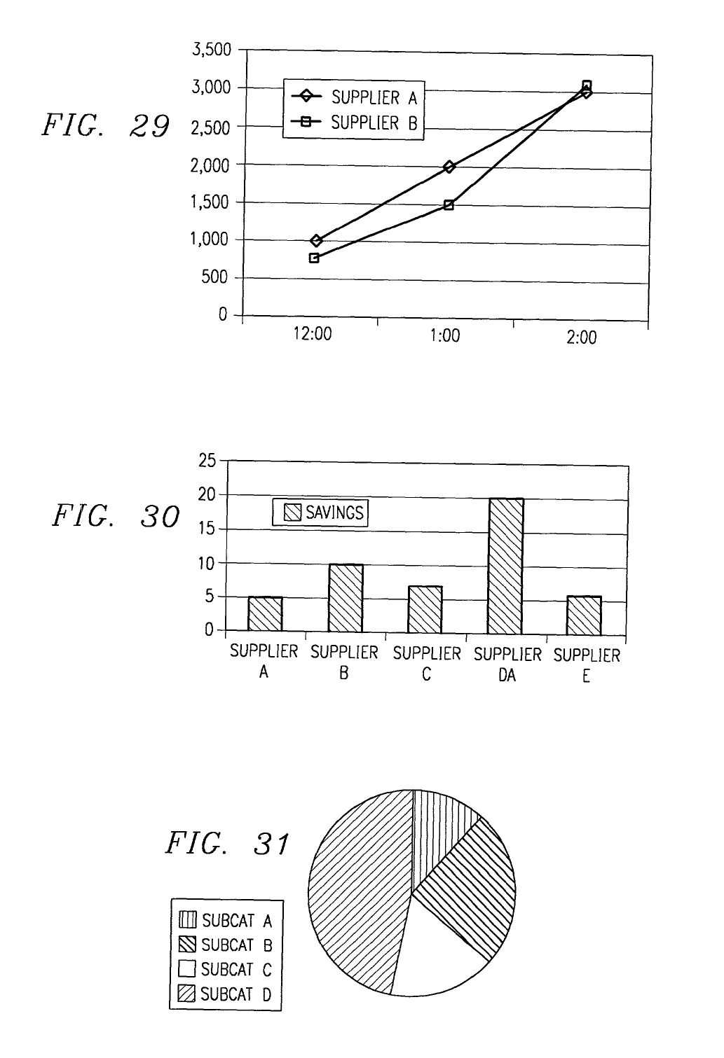

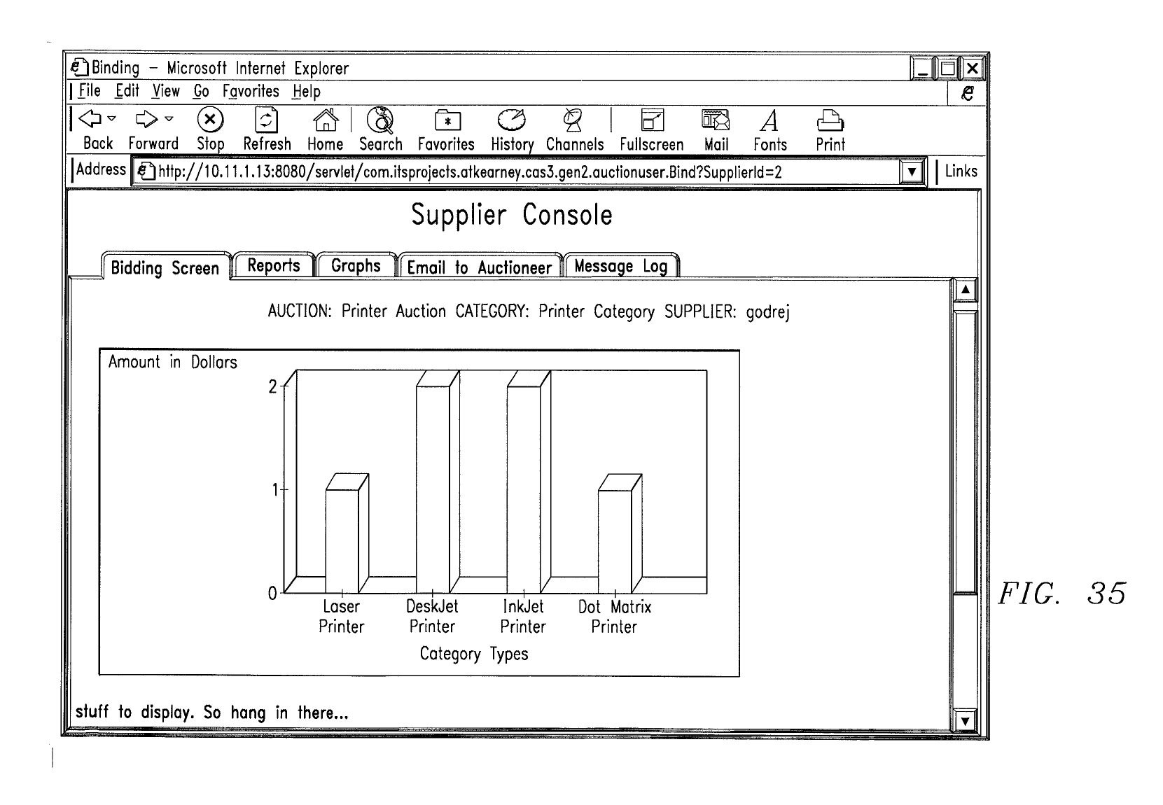

The preferred embodiment of the present invention and its advantages are best understood by referring to FIGS. 1-37 of the drawings, like numerals being used for like and corresponding parts of the various drawings.

The sourcing system and method of the present invention generally enable a purchaser to use an electronic bidding process to purchase products. Optionally, a third party implementor may assist a purchaser to obtain information on products offered by a plurality of vendors, compare the products offered by the plurality of vendors based on the plurality of parameters, and conduct a competitive total cost bidding process or auction to obtain bids from the vendors on a plurality of pre-defined parameters to determine the best comparable total cost for the selected products. The implementor could also be the purchaser itself.

The sourcing system and method of the present invention may be used for the purchase of products, a category or a subcategory of products. For simplicity, the description below focuses on downward auctions where the purchaser is trying to obtain the lowest total cost; however, the present invention could also be adapted for upward auctions where a vendor is trying to sell products at the highest total cost to one of several purchasers. In such a case, multiple parameters from the seller's perspective (including but not limited to those discussed above and below from the buyer's perspective) could be accounted for in a total cost formula. The seller would simply use the software to obtain the highest possible total cost.

A category may refer to a group of various products or services such as commodity products or complex purchase services. Subcategories may include further subclassification of a category. Each category or subcategory may have multiple parameters associated with it. For example, a category may represent a subassembly, and the sub-categories may include the associated jobs (i.e., molding, machining, stamping, etc.). As another example, a company seeking bids to supply copy machines may have a copy machine category with subcategories such as heavy use, medium use, and low use. Parameters for each subcategory might include maintenance, warranty, paper, toner, sorters, etc.

The invention may be used for various purchasing scenarios. For example, it may be used during the initial sourcing of a category (or subcategory) after an RFP has been issued to a screened set of suppliers. It may also be employed during the re-sourcing of a category (or subcategory) by a purchaser, and in recurring sourcing situations to obtain the best comparable total costs for a category of products on a regular basis. Thus, the auction software could be used separately or in combination with the RFI and RFP processes.

When a purchaser or buyer (referred to herein as a “purchaser”) desires to purchase products (i.e., products, systems, goods, supplies, equipment, services or combinations thereof), the purchaser may begin the process by engaging a facilitator, auctioneer or implementor of the system (referred to herein as the “implementor”) to assist the purchaser to purchase the products. Alternatively, the implementor may be the purchaser itself.

Overview of Sourcing Process

Referring now to the drawings and in particular to FIG. 1, an example sourcing method, generally indicated by numeral 10, includes seven general steps. The steps which are discussed in further detail below, generally include: (I) planning the auction 16; (II) developing and issuing an RFI and an RFP 24; (III) issuing specs or bid sheets 20; (IV) executing the auction 22; (V) conducting final negotiations 32; (VI) awarding a contract 28; and (VII) generating a purchase order 30. If the sourcing system is employed to re-source products or in the recurring sourcing of products, steps two and five illustrated in FIG. 1 may be omitted. It should also be appreciated that if the sourcing system of the present invention is implemented by a purchaser without the assistance of an implementor, the purchaser will perform those steps performed by the implementor. Additional steps may be included or some or all of these steps excluded without departing from the scope of the invention. The multiple parameter auction method and software may be used independently of this process as well as the processes described in more detail below without departing from the scope of the invention.

Auction Planning Process (Step I)

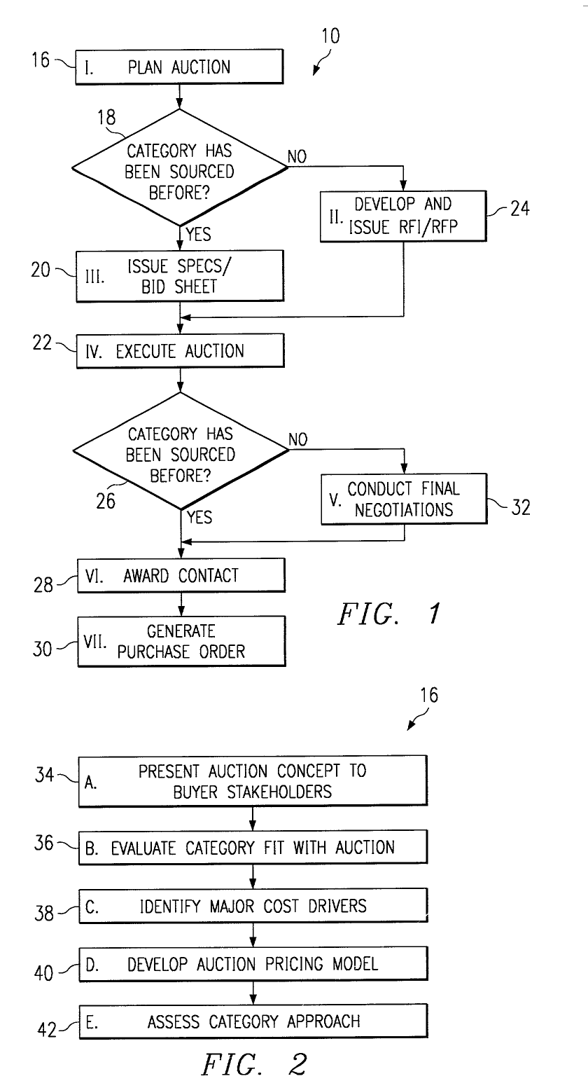

Referring now to FIG. 2, the implementor presents the auction concept to the purchaser, as indicated by block 34. This may involve demonstrating the sourcing system and discussing benefits and risks of the sourcing system with the purchaser.

Before developing an auction strategy, the implementor may determine whether an on-line real-time interactive competitive auction can be successfully implemented to source the products, category of products, or subcategory of products as indicated by block 36. Although the discussion in this application frequently refers to the auction as being on-line and real-time, the invention does not need to be used in that manner. For example, the auction does not need to occur on-line. A purchaser or an implementor may obtain paper bids or electronic bids using other software and supply the bid data to the auction software. In addition, the software can be used other than on a real-time basis. The time at which bidders and/or purchasers are able to view the status of the auction may be adjusted such that it is not in real time.

The implementor may evaluate the suitability of the auction for the category using many different criteria, some of which may include: (i) the degree to which the category includes commodity products; (ii) the clarity of vendor equipment specifications; (iii) the number of subcategories (i.e., whether there is a large or small number of biddable line items); (iv) whether non-price parameters can be quantified; (v) whether pricing elements ancillary to the base unit cost (warranties, discounts, etc.) are easily defined and benchmarked; (vi) the number of non-price parameters; (vii) whether the value of non-price parameters is significant compared to base unit cost; (viii) the rivalry of the vendor market; (ix) whether there is a sufficient number of vendors for each sub-category; (x) whether the size of purchaser's spend level is large enough to generate significant competition; (xi) whether the costs for changing vendors are minimal; (xii) whether the vendor pool has comparable peers; (xiii) whether the vendor capabilities are similar; (xiv) whether the vendors can be grouped into categories of three to four similar peers, so that separate auctions can be held; (xv) whether logistical issues are minimal; (xvi) whether vendors are familiar with a web browser and email, and have easy internet access; (xvii) whether vendors in all relevant time zones can participate; and (xviii) whether currency and exchange rate issues can be easily managed. It should be appreciated that these criteria are general guidelines for a successful auction candidate, not prerequisites for conducting an auction. In other words, the auction software of the present invention may be used to conduct an auction regardless of these criteria.

As part of the auction planning step, the implementor may identify several (preferably three to four) major cost drivers, as indicated by block 38. It should be appreciated that the number of major cost drivers could vary. The major cost drivers may be used by the implementor to determine the comparable total cost for the products and generally include the base price plus applicable warranties, ancillary charges, discounts, rebates and other charges or expenditures, which the system identifies as parameters. Such parameters may include items for which a price is charged or other more subjective parameters. Where parameters are subjective, the purchaser and/or implementor may quantify the parameter and assign it a cost based upon the importance of the factor to the purchaser. In addition, one or more formulas may be used to convert a parameter into a cost to be taken into account in a total cost formula. For example, where a purchaser of equipment expects equipment to fail periodically, the mean time to failure for such equipment may be used to calculate the projected cost of the downtime for the equipment (such as, for example, where the downtime causes an assembly line to be halted).

Thus, parameters may either be price or non-price parameters. Examples of price parameters include: (i) base price; (ii) volume discounts; (iii) rebates; (iv) life cycle discounts; (v) utilization charges; (vi) maintenance charges; and (vii) administration charges. Examples of non-price parameters include: (i) delivery timing; (ii) national service coverage; (iii) quality levels; (iv) employee skill levels and training; (v) dedicated account management team resources; (vi) custom reporting services; (vii) online ordering; (viii) length of warranty; and (ix) length of contract. In addition to variable parameters, the cost drivers may also include fixed values such as switching costs or other fixed costs of the supply relationship.

The implementor develops an auction pricing model, as indicated by block 40, as part of planning the auction. In addition to the selection of parameters, the implementor works with the purchaser to select the products or items that will be bid on by the vendors, which the system identifies as sub-categories. To define the subcategories, the purchaser identifies the highest impact items for inclusion in the auction (e.g., the ten items that make up 80% of the projected spending for the category). The sub-categories are then grouped in logical categories (i.e., sub-categories could represent a set of jobs—molding, machining, stamping—associated with the production of a subassembly, and the category could represent the subassembly). For categories with thousands of items, the auction pricing model can be simplified by developing a market basket of representative items. For example, in the office supplies category, the purchaser may select the one hundred items making up the most significant purchases from the thousands of items and group them into ten sub-categories. During the RFP process, the vendors bidding in an auction may provide pricing for each product in the market basket, sub-totaled at the sub-category level. During the auction, the vendors may bid at the subcategory level. This enables the system to handle bidding on a relatively large number of items in a manageable fashion. Bidding could, however, occur at the product level.

Using the selected parameters and sub-categories, the implementor creates a total cost formula for each vendor. The total cost formula may be the same for all participants in an auction or may be specific to each vendor. The ability to use a formula specific to each vendor allows the software to take into account cost items specific to a particular vendor such as the cost of converting from one vendor to another. (For example, there may be costs in setting up accounting/payment systems to take the new vendor into account as well as a cost of physically changing out equipment.) As part of defining the formula, the implementor determines the unit labels and cost constant assigned to each of the parameters as further explained below. Thus, as defined herein, total cost is the costs to the purchaser for the products or category of products based on the selected parameters and subcategories.

Planning the auction may also include assessing the category approach, as indicated by block 42. If a category has not been sourced before, a typical approach is to use the RFI and RFP processes. If the category has been sourced before, and the vendor base is well known, then the category re-sourcing or recurring sourcing approaches may be used.

RFI and RFP Development and Issue Process (Step II)

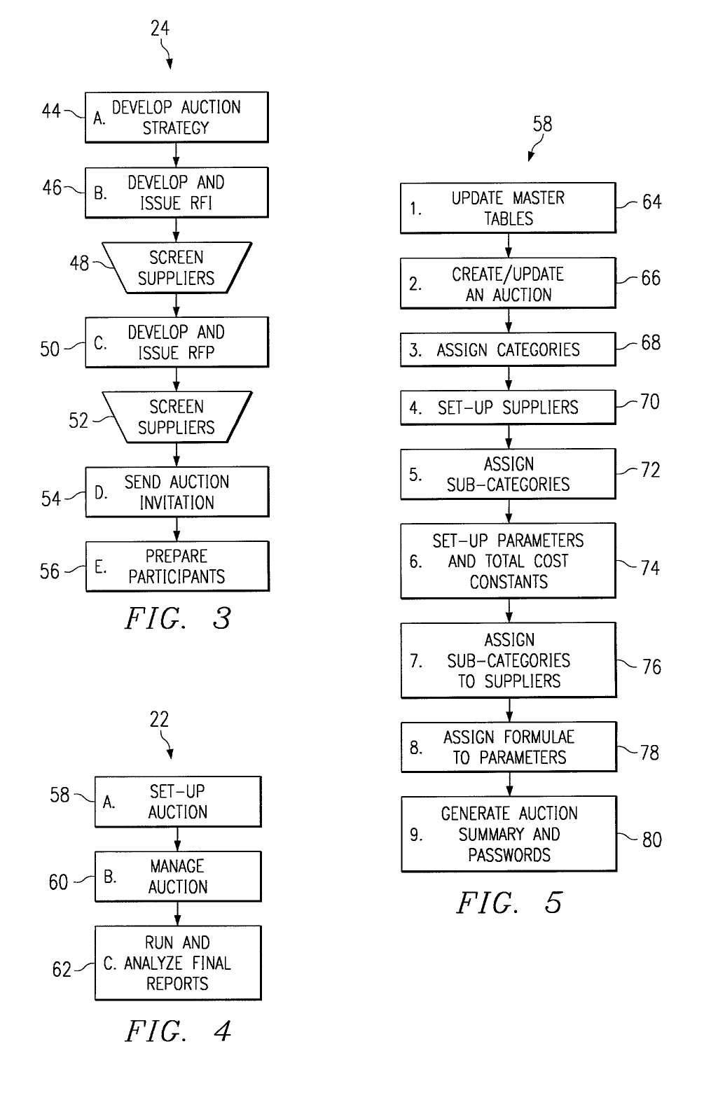

FIG. 3 illustrates a process for developing, reviewing and issuing an RFI and an RFP. Before developing the RFI, the implementor develops an auction strategy, as indicated by block 44, considering such factors as the: (i) number of auctions; (ii) number of vendors; (iii) auction sequence in the vendor selection process; (iv) pricing model; (v) auction disclosure plan; and (vi) pricing feedback format. This auction strategy guides the development of the RFI and RFP.

The implementor assists the purchaser to develop and issue an RFI to determine the interested vendors in addition to defining the product specifications and requirements, as indicated by block 46. The RFI is typically a relatively short survey sent to a number of potential vendors in a product field or supply line (i.e., a first list of vendors). The vendors receive the RFI and provide a response thereto to the purchaser. The implementor assists the purchaser in evaluating the RFI responses and selecting vendors based on their responses to the RFI, forming a second screened list of vendors as indicated by block 48. Only those selected vendors on the second list of vendors are sent an RFP.

The RFP is developed and issued as indicated by block 50. The RFP generally establishes the auction terms and rules. Factors considered in developing the RFP include defining: (i) equipment/service specifications; (ii) minimum service requirements; (iii) a minimum baseline for the parameters where applicable (e.g., warranties, volume discounts, etc.); and (iv) the scope of the award (e.g., size of award, timing, target number of vendors to be selected, etc).

The purchaser transmits or communicates the RFP to all of the screened or selected vendors on the second list of vendors. The vendors receive and provide a response to the RFP. The implementor assists the purchaser to evaluate the responses to screen and select the vendors based on their responses to the RFP, forming a third list of vendors 14 who will participate in the auction as indicated by block 52. Alternatively, the second list of vendors can simply be allowed to participate in an auction. As noted above, the RFP and RFI process is not required as part of the invention. It should be appreciated that the RFI and RFP may be issued electronically, sent by facsimile, mailed or sent by any other well-known means to the vendors.

After forming and finalizing the third list of vendors 14, the implementor or purchaser sends an auction invitation to the listed vendors as indicated by block 54. The invitation may include, for example: (i) the schedule of key dates for the auction; (ii) the auction vendor manual; (iii) the auction information sheet; (iv) the practice auction instructions, login ID and password; and (v) any other relevant information regarding the auction. The implementor may prepare all the auction participants for the auction, as indicated by block 56. The implementor may prepare the purchaser by: (i) providing the data requirements and templates to the purchaser; (ii) discussing the purchaser's role; (iii) conducting a practice auction; (iv) establishing the purchaser's onsite auction war room which includes ensuring external internet access; and (v) discussing contingency planning, such as purchaser's loss of internet access, a vendor's loss of internet access, server failure and other potential problems. The implementor may prepare the vendor by: (i) providing an auction help desk having a toll free number and email address; (ii) conducting a vendor information session; (iii) monitoring vendor participation during a practice auction; (iv) troubleshooting technical problems including calling vendors that do not submit bids in the practice auction; and (v) ensuring that the vendors understand the auction process.

Issuing Bid Sheet (Step III)

The purchaser or implementor may provide the vendors with the sub-category specifications and a bid sheet for conducting the auction. The bid sheet is a simplified version of the RFP which includes: (i) subcategories; (ii) parameters; (iii) product specifications; and (iv) minimum service requirements.

Executing the On-Line Bidding Process (Step IV)

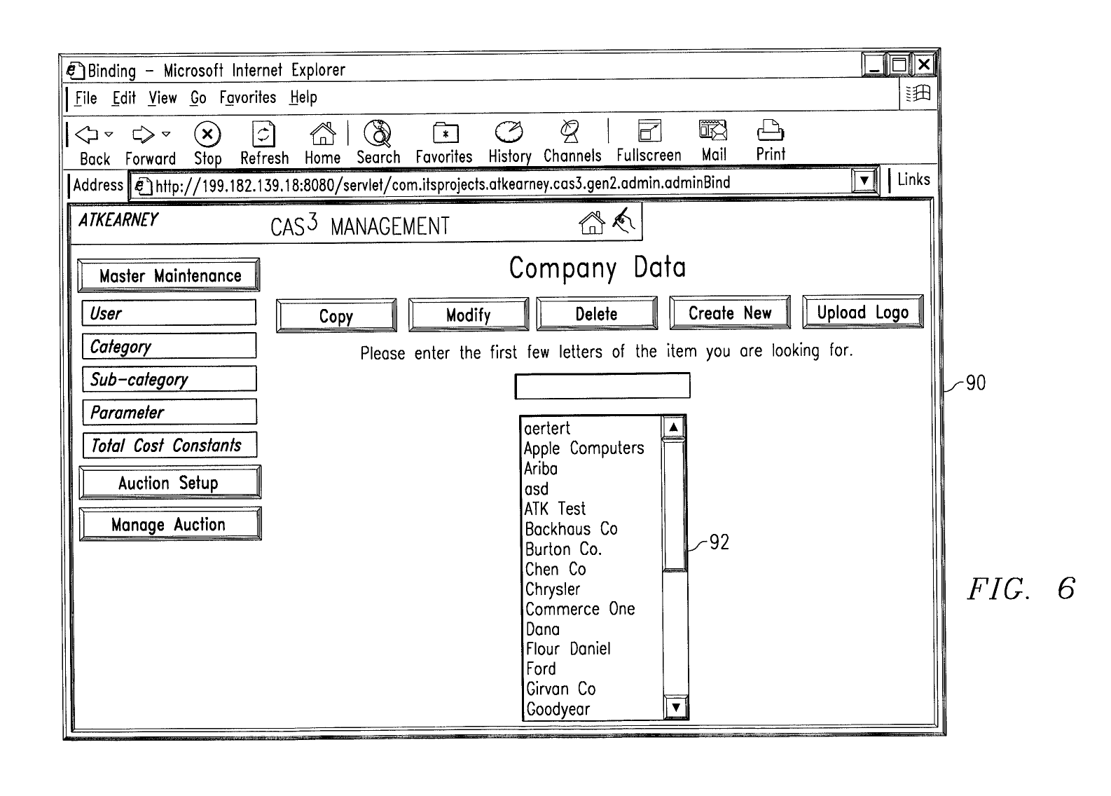

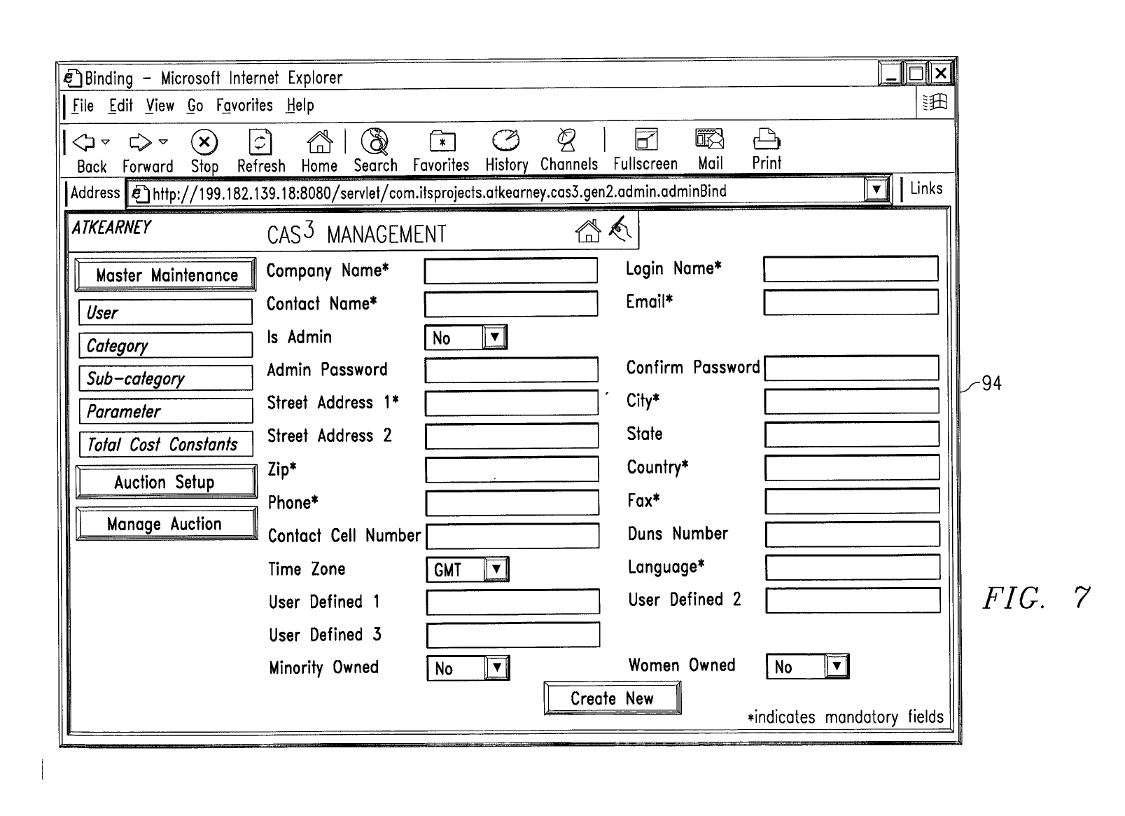

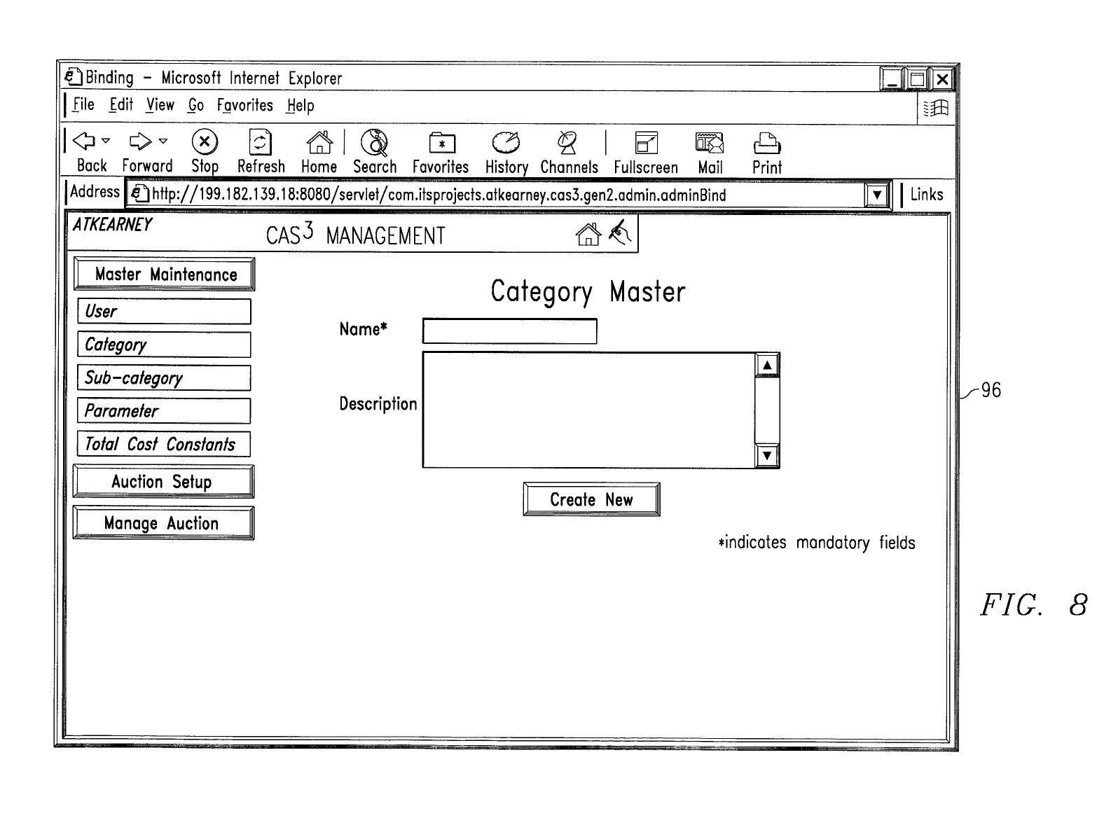

Referring now to FIGS. 4 and 5, the implementor executes the auction by setting up the auction, managing the auction and generating and analyzing one or more final reports based on the auction, as indicated by blocks 58, 60 and 62, respectively. More specifically, setting up the auction may include: (i) updating the master database tables for that auction as indicated by block 64; (ii) creating an auction, as indicated by block 66; (iii) assigning categories for the auction as indicated by block 68; (iv) setting-up the vendors for the auction as indicated by block 70; (v) assigning sub-categories to the categories of the auction as indicated by block 72; (vi) setting-up the parameters and total cost constants for the auction, as indicated by block 74; (vii) assigning subcategories to the selected vendors for the auction, as indicated by block 76; (viii) assigning a formula for each parameter to calculate the comparable total cost for each vendor for the auction, as indicated by block 78; and (ix) generating the auction summary and passwords, as indicated by block 80.

The discussion below addresses several example interfaces that may be used with the present invention. These interfaces are only examples and other interfaces could be used without departing from the scope of the invention. In addition, the interfaces could accept more or less information and organize the information differently without departing from the scope of the invention.

Updating the Master Database Tables

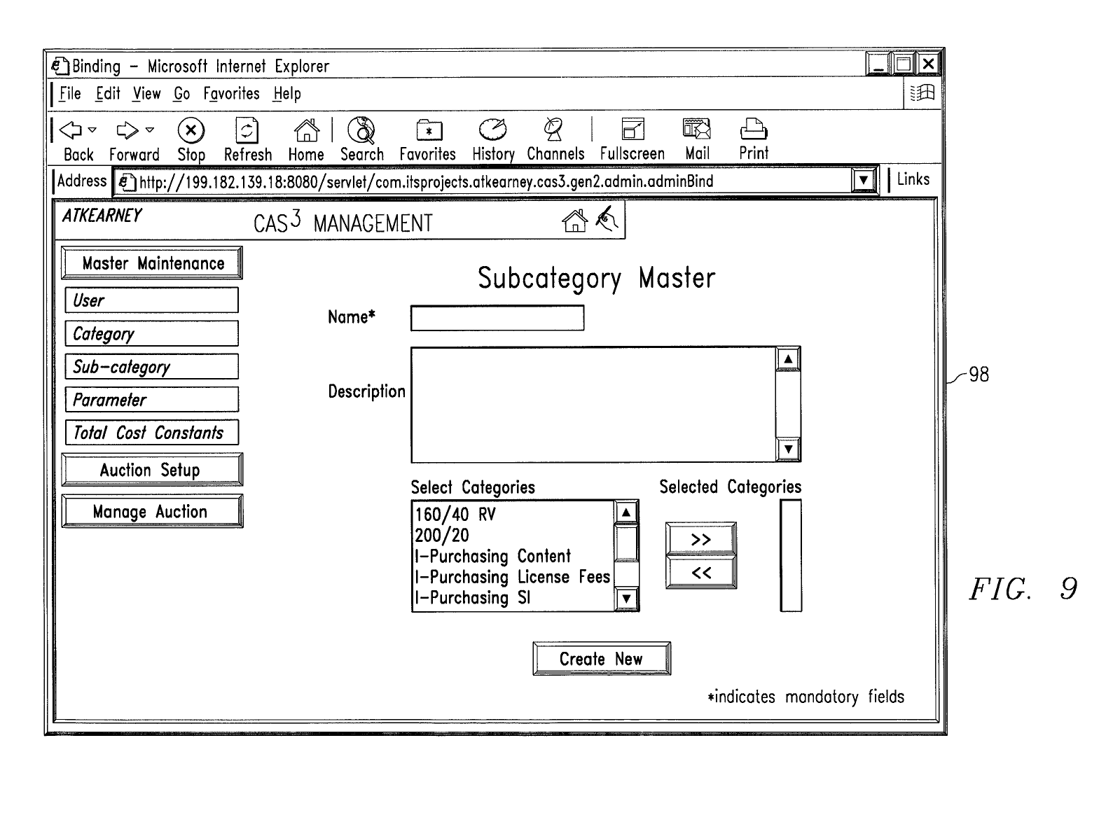

Referring now to FIG. 6, the system may provide a master database table 90 interface which enables the implementor to add new supplier, category, subcategory, parameter and total cost information to the database. These elements constitute the building blocks of the auction set-up. To determine if information already exists in the database, the system provides a search interface as illustrated in box 92. The interface enables the implementor to copy and/or modify pre-existing information as well. At any point in the auction set-up, the implementor may return to the master tables by clicking on the navigation bar at the left side of the screen, or by clicking on links to specific master tables.

Although this embodiment of the invention employs categories and subcategories of products, this organization need not be used in accordance with the invention. The invention may encompass any auction software that uses a plurality of parameters, rather than simply cost, to determine the outcome of the auction.

User Master Information

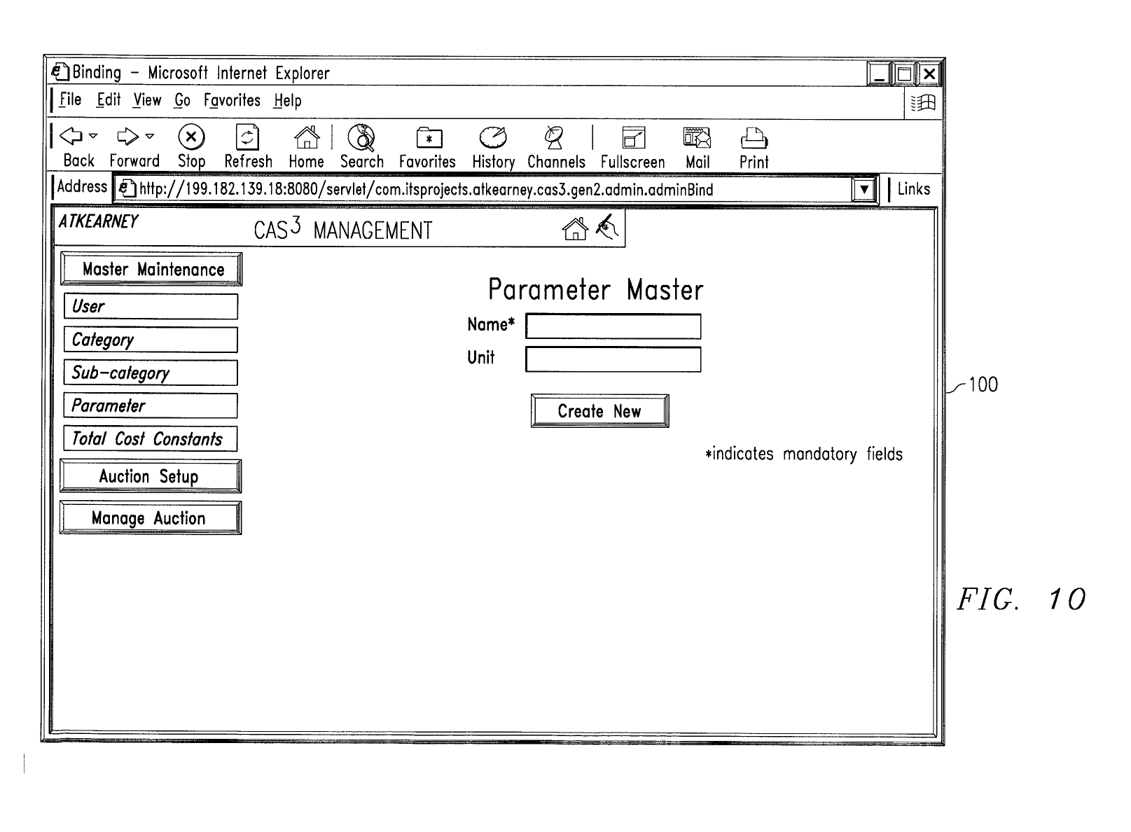

Referring now to FIG. 7, the system may provide a user master information input interface 94 which enables the implementor to input relevant purchaser and/or vendor information for the auction. Relevant user information may include the company's name, address, contact information, e-mail address, time zone, currency, language, company logo, DUNS #, e-mail address, login name, and other implementor defined fields. Additional information could be included or some of this information excluded without departing from the scope of the invention. After the implementor inputs this data, the system stores this information in the appropriate database.

Category Master Information

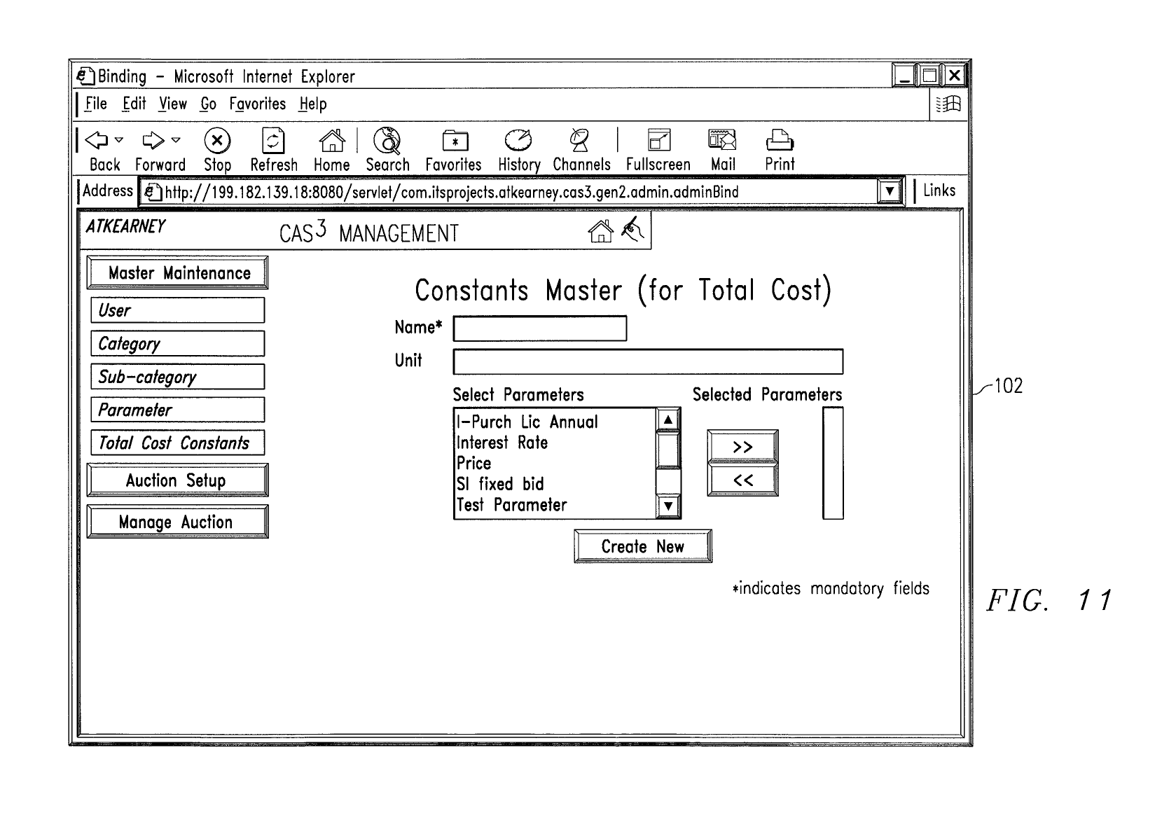

Referring now to FIG. 8, the system may provide a product or category master information input interface 96 which enables the implementor to create a new category or product in the system database. This interface 96 enables the implementor to input the name of the category or products and a description of the product for the auction in the master tables in the database. After the implementor inputs this information or data, the system stores this information in the appropriate database.

Sub-Category Master Information

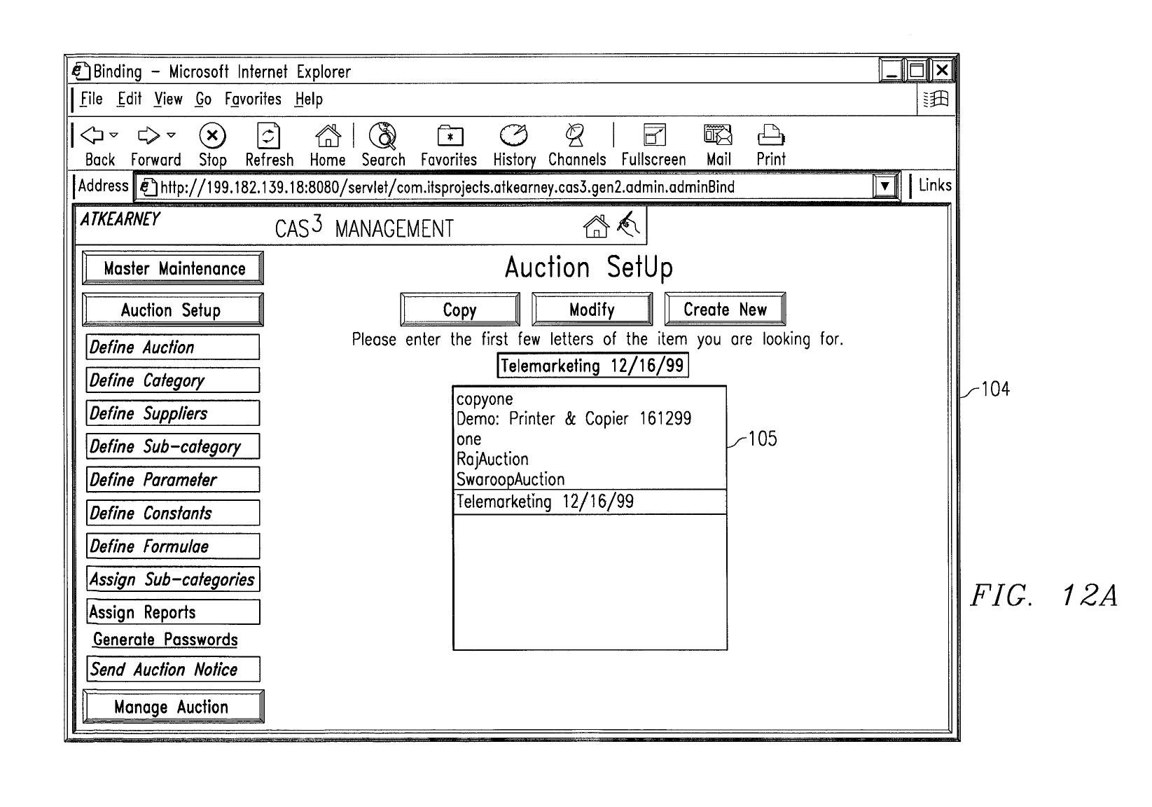

If the implementor creates a new category, the implementor may create and assign sub-categories to the new category. The implementor may also create new subcategories for existing categories. Turning now to FIG. 9, the system 10 may provide a sub-category master information interface 98 which enables the implementor to input the subcategory information relevant to the auction. In particular, the interface enables the implementor to enter the sub-category name and description of the subcategory. The implementor also selects which categories to add the sub-category to. After the implementor inputs this information or data, the system stores this information in the appropriate database.

Parameter Master Information

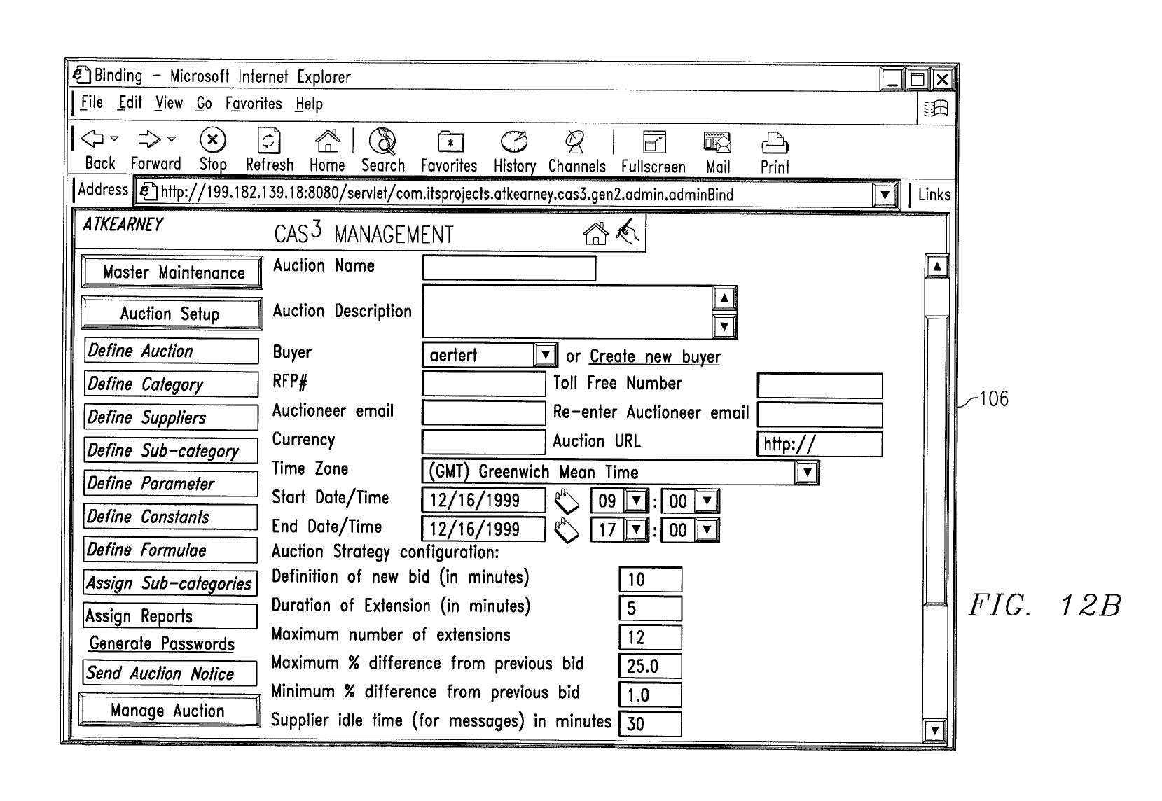

The implementor may also set up the plurality of parameters for the total cost formula for the sub-category. Turning now to FIG. 10, the system provides a parameter (or variable) master information input interface 100 which enables the implementor to input the name of the parameter and a description of the parameters. After the implementor inputs this information or data, the system stores this information in the appropriate database. Such information may be used to create a total cost formula that takes into account multiple parameters associated with a product.

Constant Assignment Information

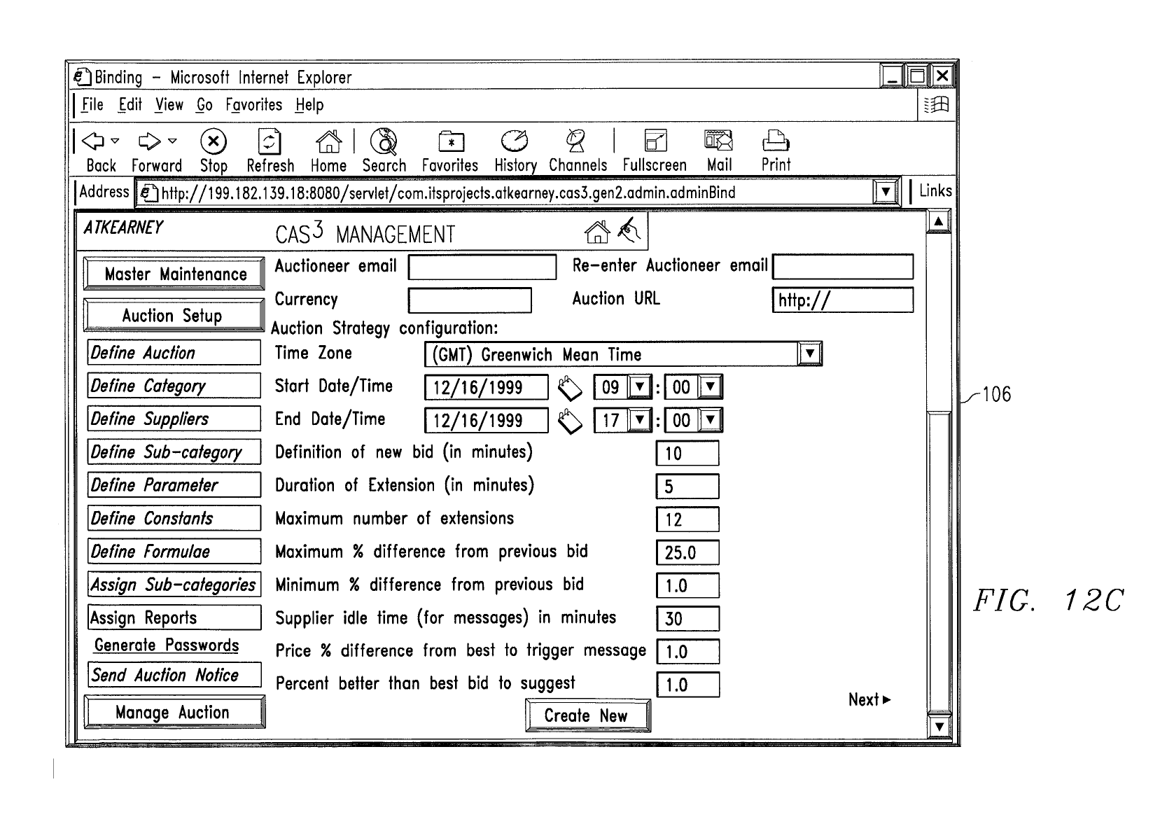

Turning now to FIG. 11, the system may provide a constant master information input interface 102 which enables the implementor to input the name and description for constants which may be used in the total cost formula. The implementor inputs the name of the constant, a description of the constant, and selects a parameter to which the constant is assigned. After the implementor inputs this information or data, the system stores this information in the appropriate database.

Create/Update an Auction

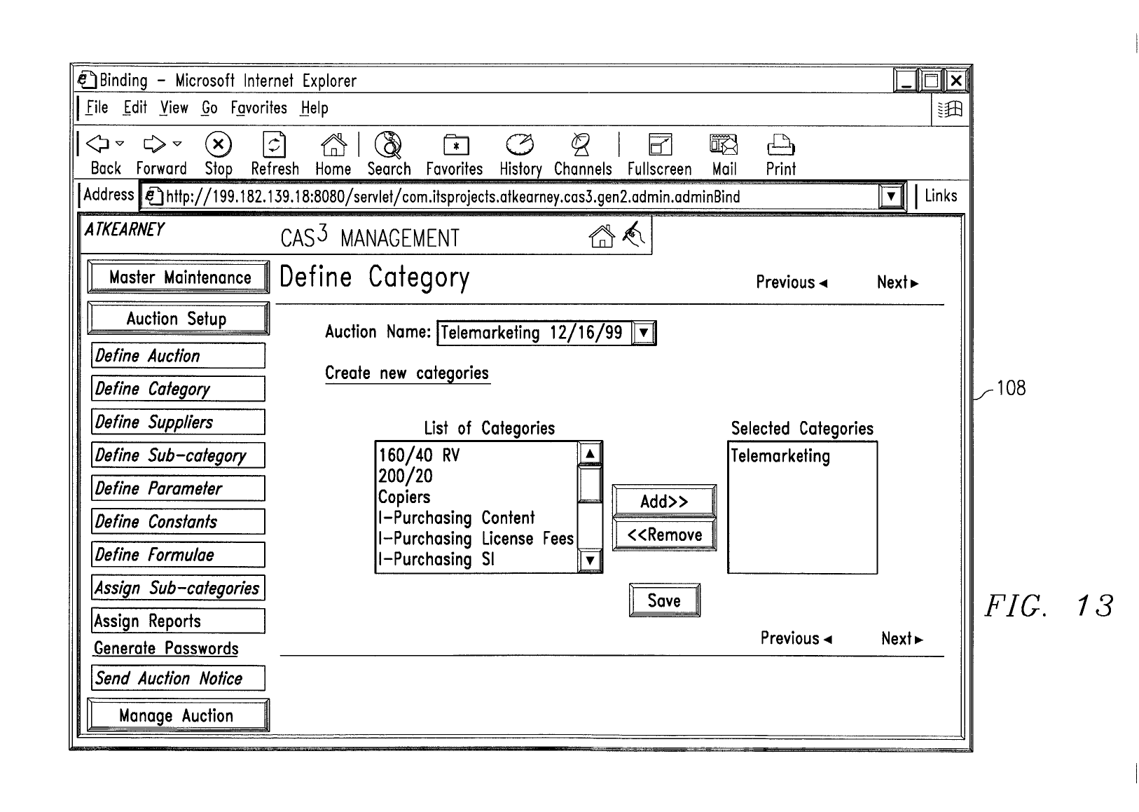

Referring now to FIG. 12A, the system may provide an auction search interface 104 which enables the implementor to copy all elements of an existing auction, or modify the auction identification information for an existing auction. To determine if an auction already exists in the database, the system provides a search interface as illustrated in box 105. The interface enables the implementor to modify a selected auction, to copy a selected auction template or structure if desired, or to create an entirely new auction. By copying an auction previously set-up, the new auction includes all the information from the previous auction such as the purchaser, the vendors, all categories, subcategories, parameters and the constants for the bid formula for determining the total cost.

When the implementor selects, copies or creates a new auction, the system provides the implementor an auction identification interface 106 as further illustrated in FIG. 12B which enables the implementor to input the auction identification information. The auction identification interface 106 illustrated in FIG. 12C enables the implementor to input the details concerning a specific auction, including the auction name, name of the purchaser, RFP number, implementor e-mail address, duration of the auction including the start date time and end date time, currency, time zone, duration of extension of the auction in minutes of the auction, maximum number of extensions that will be granted for a particular auction, maximum percentage difference between a vendor's two consecutive bids, minimum percentage difference between a vendor's two consecutive bids, the maximum vendor idle time in minutes after which a vendor will be sent an e-mail message prompting him to bid, the gap between the current lowest bid and vendor's bid which will cause the system to send a message to the vendor to make a more aggressive bid to become the best bidder, and the definition of a new bid which is the elapsed time in minutes between the two latest bids of any two vendors. When the implementor wants to save the changes, the implementor selects the “submit” icon and the system stores the inputted auction information in the master database tables in the database server discussed below.

Category Assignment

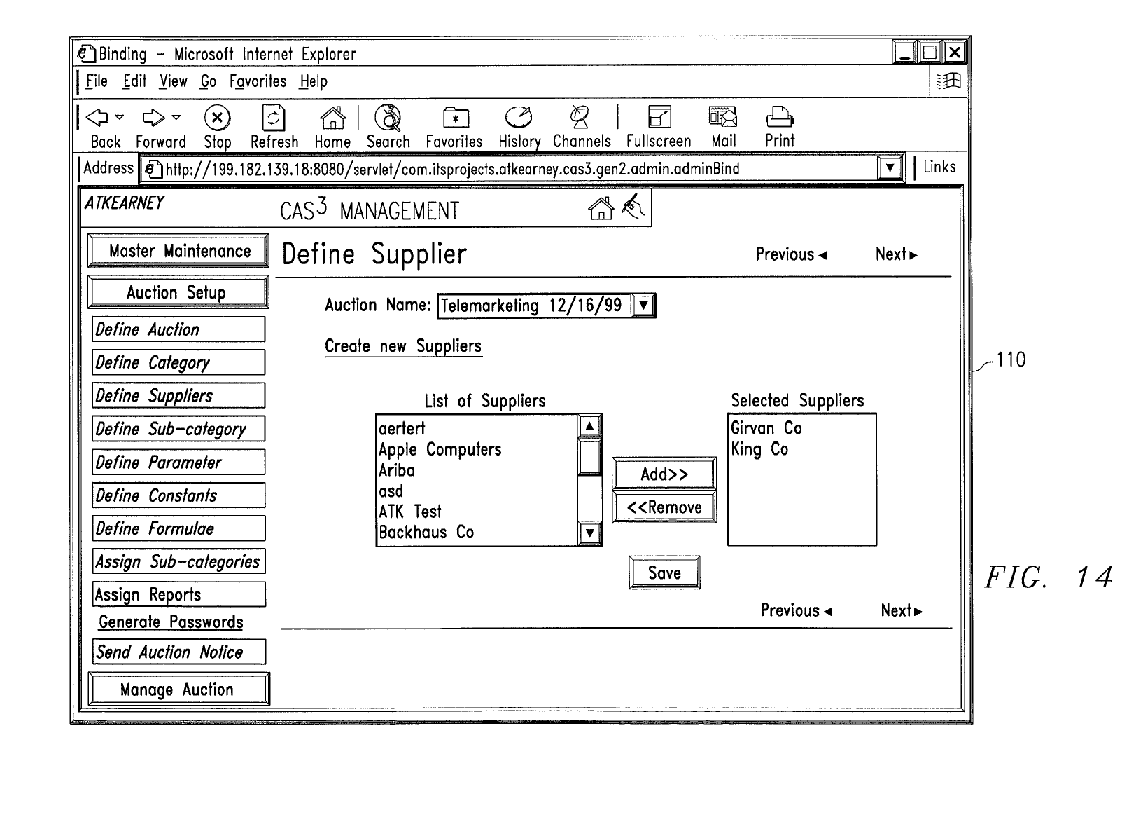

To set up the auction, the implementor assigns categories to the auction. FIG. 13 illustrates an example category assignment interface 108 which enables the implementor to select an auction and categories. The interface enables the implementor to assign selected categories to the auction. After the implementor inputs this information or data, the system stores this information in the appropriate database. If the implementor has not created a new category or the category does not exist on the system, the implementor may access the category master interface 96 through the link on the interface 108.

Vendor Setup

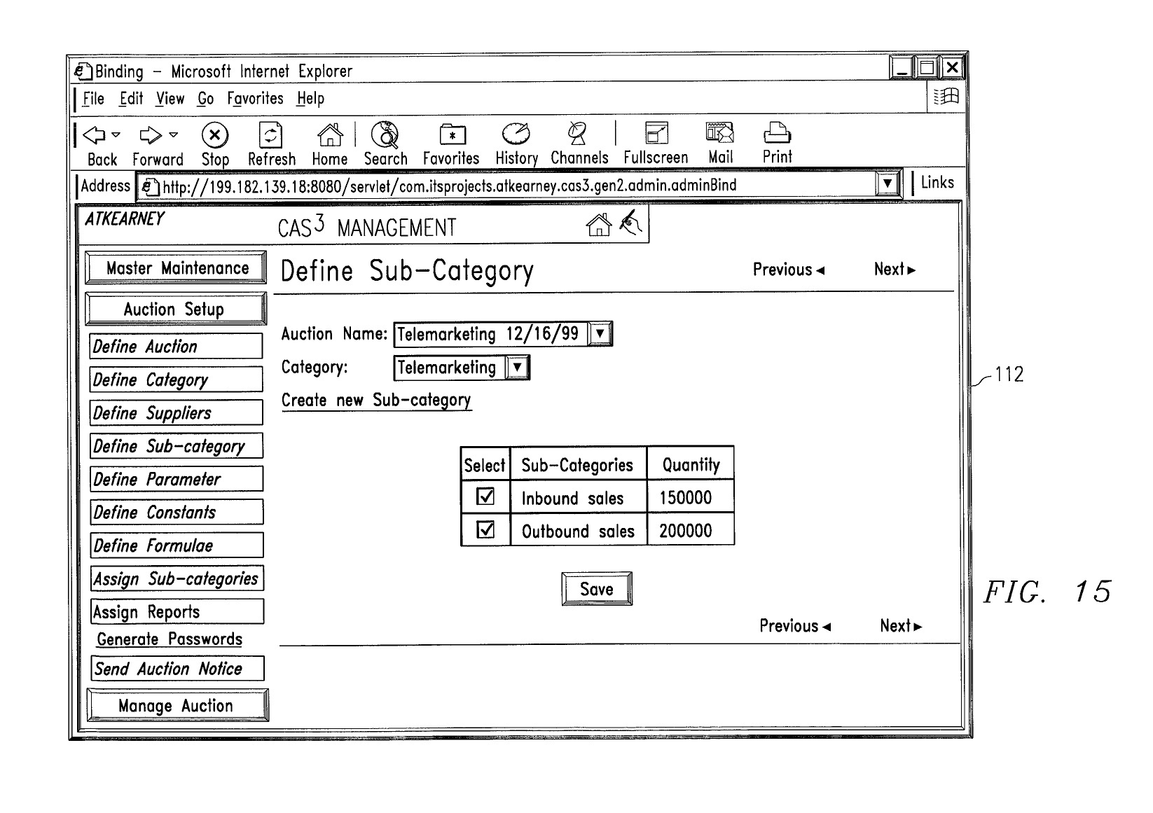

The implementor may also identify the invited vendors who will participate in the auction. Where an auction has no restrictions, any vendor may be allowed to participate. Referring now to FIG. 14, the system may include a vendor assignment interface 110 which enables the implementor to select an auction and input the list of vendors who will participate in the auction. The implementor selects the vendors from the vendors previously stored on the system database using the vendor master information input interface discussed previously (referred to as “vendor master list”). The implementor selects each invited vendor from the vendor master list so that the invited vendors are displayed in the appropriate box (referred to as “selected vendors”). After the implementor inputs this information or data, the system stores this information in the appropriate database.

Sub-Category Assignment

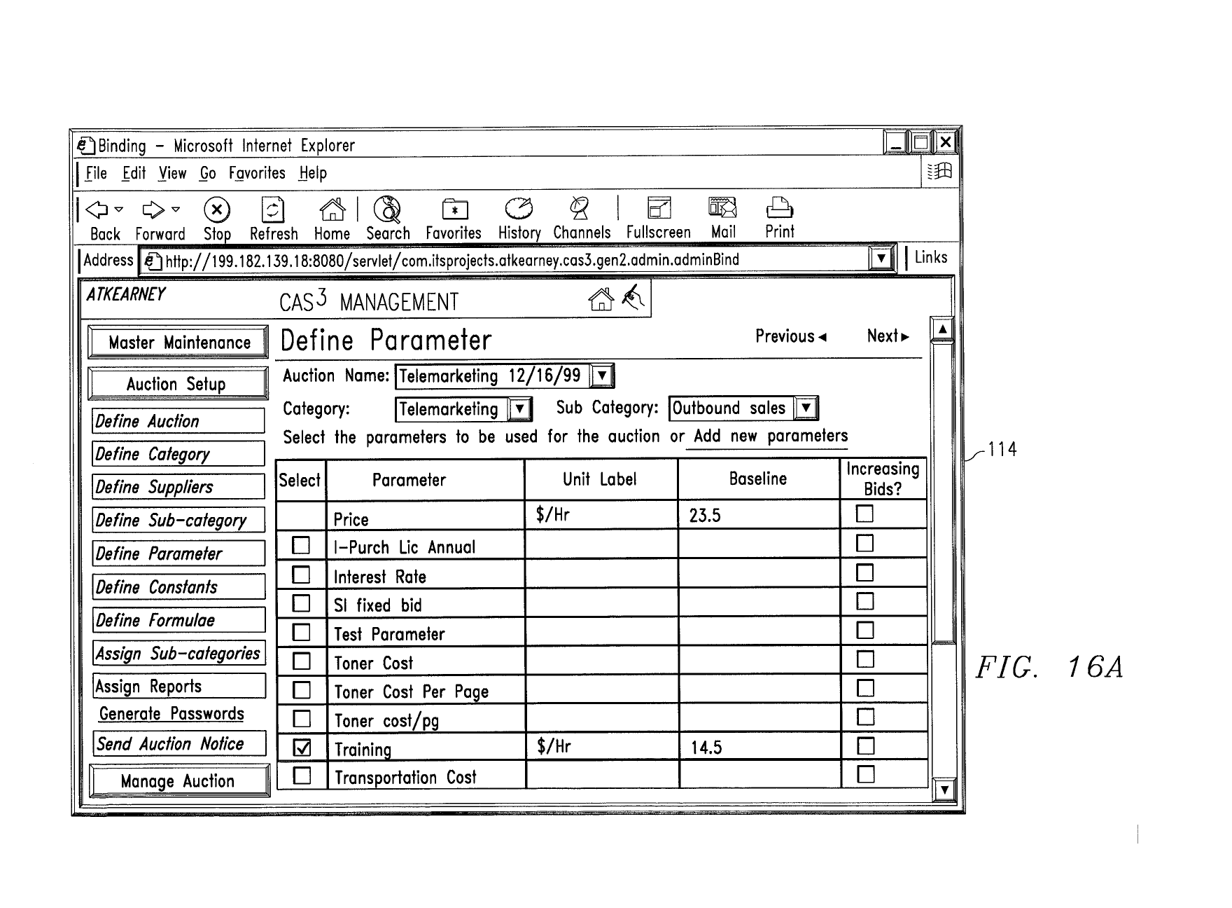

The implementor may also assign sub-categories for each category on which bidding will occur during the auction. Referring now to FIG. 15, the system may provide a subcategory assignment interface 112 which enables the implementor to select the particular auction, category and associated subcategory. In addition to using interface 112 to select the subcategories for the auction, the implementor may use this interface to define the quantity for each of the selected sub-categories. After the implementor inputs this information or data, the system stores this information in the appropriate database.

Parameter Set-Up

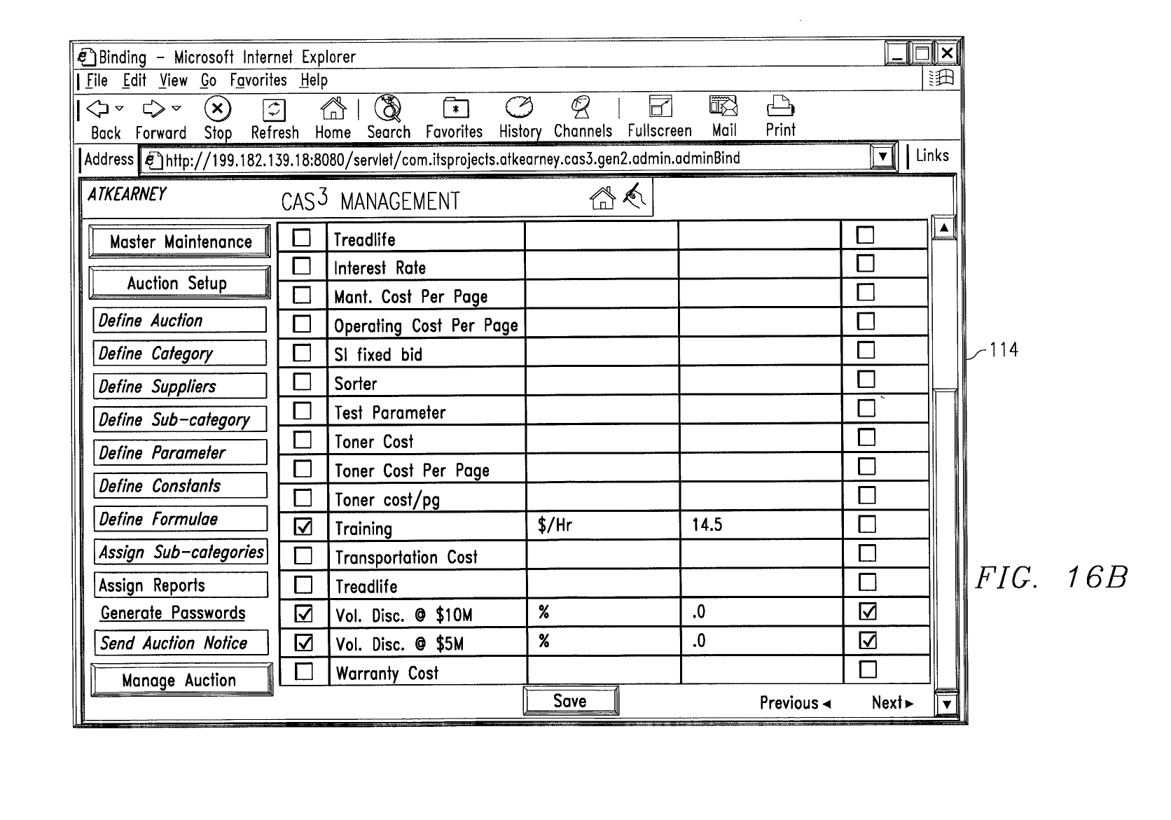

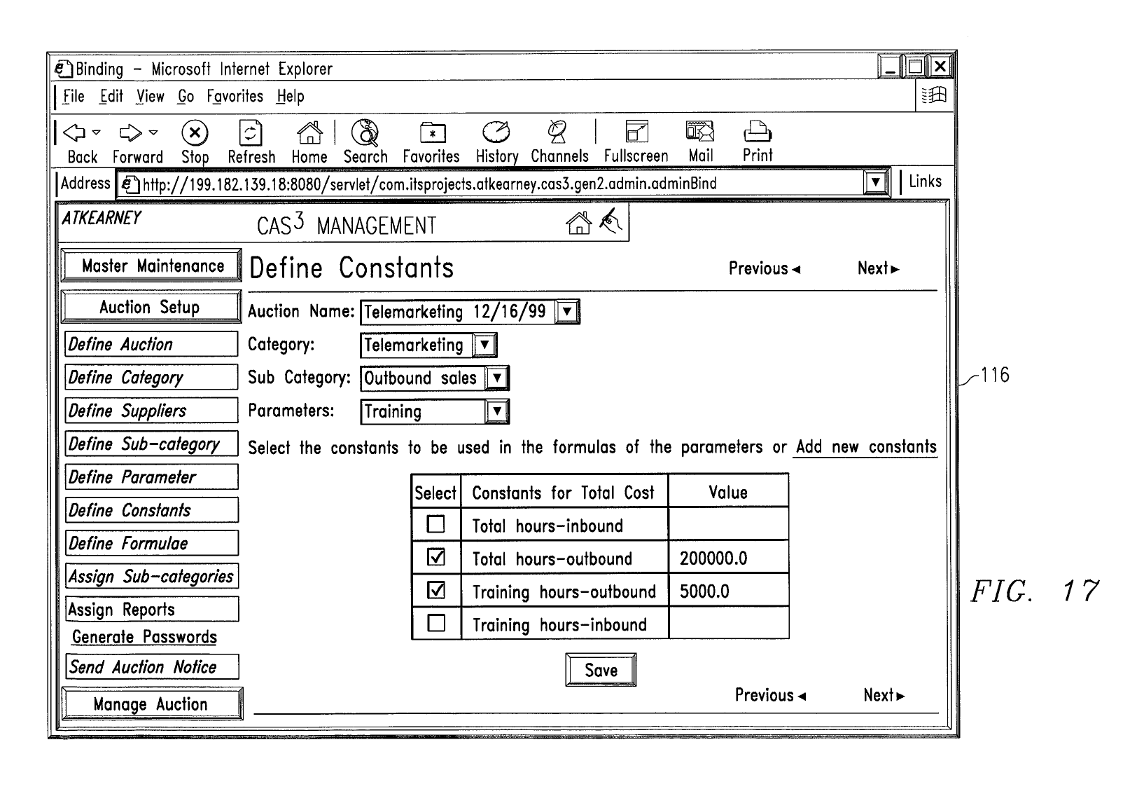

Referring now to FIGS. 16A and 16, the system may provide a parameter set-up interface 114 which enables the implementor to assign parameters (i.e., variables) to each of the sub-categories and enter baseline values for each parameter. The baseline values are used by the system to calculate the purchaser savings as explained below. Baseline values may reflect, for example, prior spending by the purchaser. This baseline information is not accessible by the vendor. The interface enables the implementor to select the auction, category and sub-category to which the parameters are assigned. The implementor also defines the unit label of measurement and the direction of bidding (upward or downward) for each of the parameters. After the implementor inputs this information or data, the system stores this information in the appropriate database.

Constants Set-Up

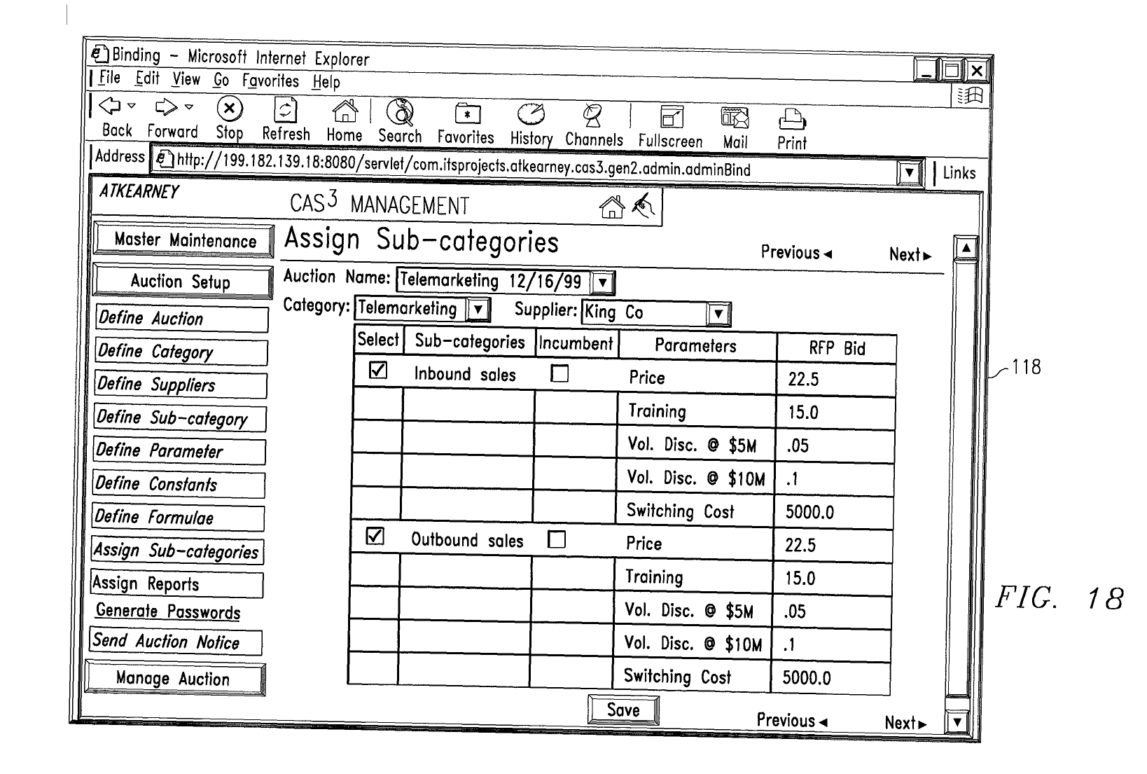

The implementor may also establish constants for calculating the total costs. Turning now to FIG. 17, the system may provide a constants assignment and setup interface 116 which enables the implementor to assign a constant to a selected parameter and define a value for that constant. The interface enables the implementor to select the auction, category, subcategory and parameter for which the constant is assigned. The interface also enables the implementor to select and define a value for each parameter. After the implementor inputs this information or data, the system stores this information in the appropriate database.

Sub-Category to Vendor Assignment

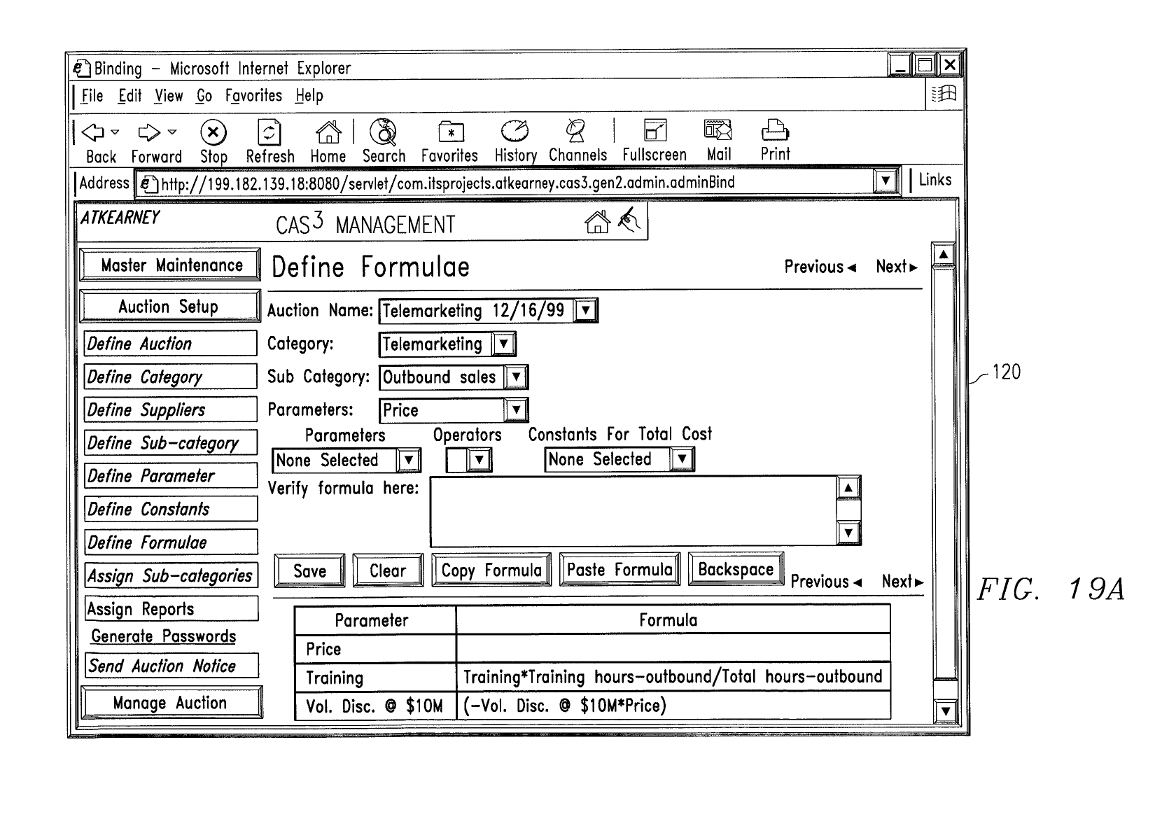

Referring to FIG. 18, the system provides a subcategory-to-vendor assignment interface 116 which enables the implementor to assign specific sub-categories to the vendors, enter bid values specified by the vendor in the vendor's response to the RFP, and specify which vendors have elected to submit bids for which subcategories. It should be appreciated that some of the vendors may be invited to bid on all the subcategories, while other vendors may be invited to bid on only specific subcategories. The implementor also uses this interface 108 to enter switching costs (fixed costs to set up non-incumbent vendors) or other supplier-specific fixed costs of the supply relationship. This information may be used in the total cost calculation. The implementor selects the specific auction, category and vendor for which the subcategory is assigned. The sub-categories table enables the implementor to select those sub-categories of interest to each selected vendor from a table of currently available sub-categories for a specified category. After the implementor inputs this information or data, the system stores this information in the appropriate database.

Formula Assignment

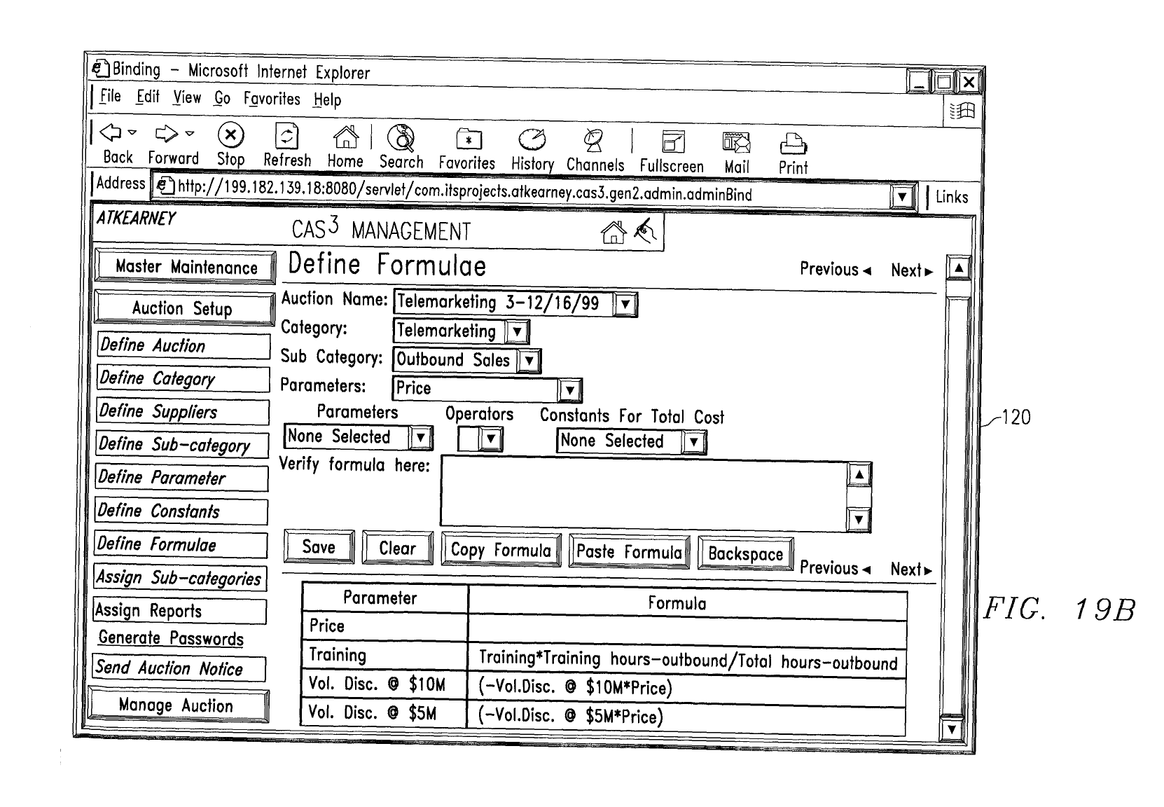

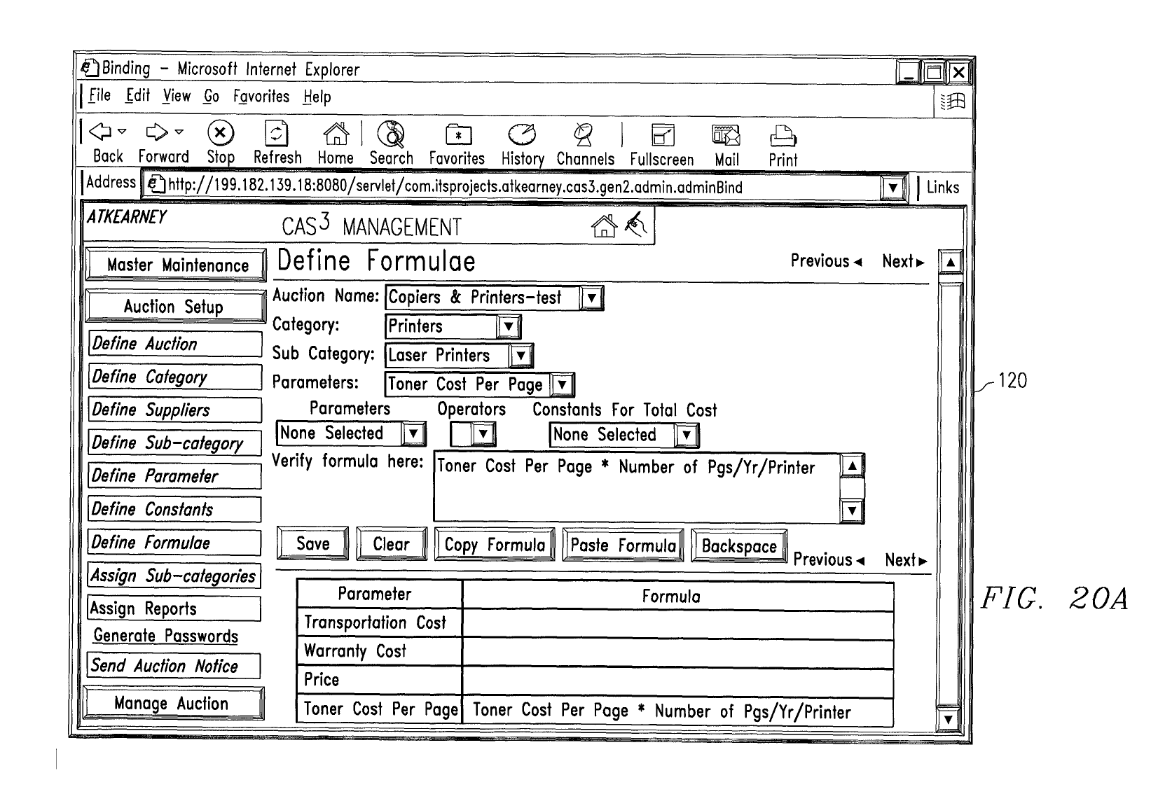

Referring now to FIGS. 19A and 19B, the system may provide a formula assignment interface 120 which enables the implementor to input a total cost calculation formula. The interface enables the implementor to assign a formula for each parameter within a sub-category. The individual parameter formulae are summed to determine the total comparable cost for the sub-category). The total cost formulae may be defined at a unit-cost level, then are multiplied by the total volume. The system calculates the total cost for each vendor using the formulae entered on this interface 110, and the bid values entered by each vendor.

The interface enables the implementor to select the auction, category, subcategory and parameter and assign a formula. This interface 110 also enables the implementor to edit and/or copy the formulae. The system verifies that only one formula is input for each parameter. After the implementor inputs this information or data, the system stores this information in the appropriate database.

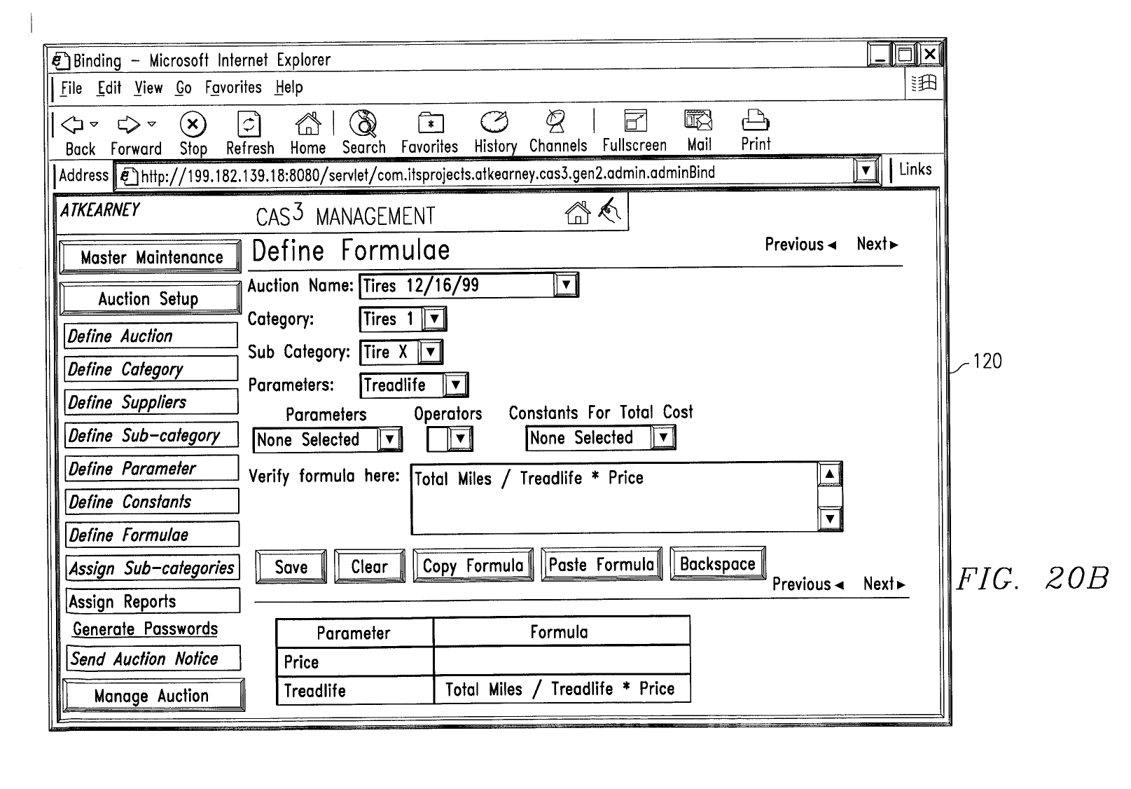

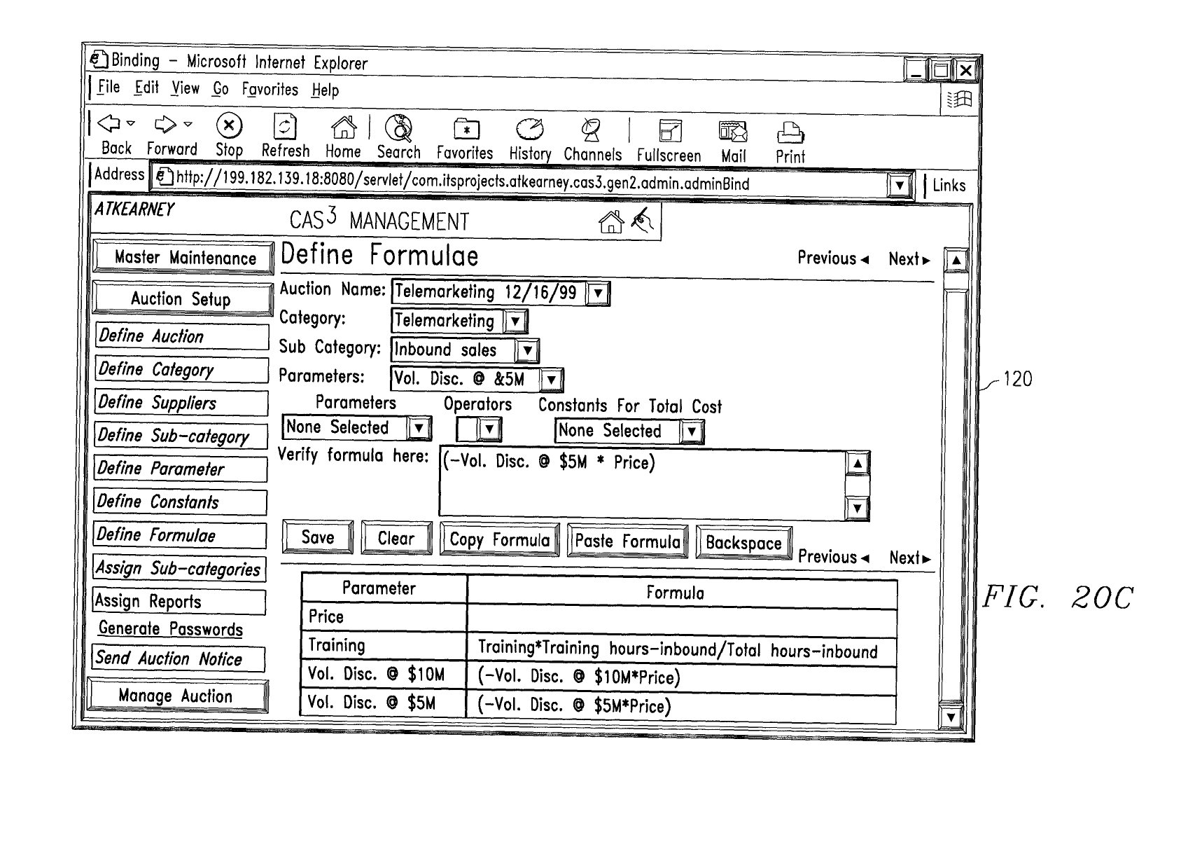

FIGS. 20A, 20B and 20C provide examples of formulas for each sub-category or category, defining the formulas for converting the vendors' bids to total comparable costs.

### EXAMPLE A

FIG. 20A illustrates a total cost formula for an example sub-category, laser printers. In this example, the total cost is driven by three parameters: price, warranty and toner cost. The total cost calculation is: Price+Warranty+Transportation cost+(Toner cost*Pages per yr avg), where price, warranty, transportation cost and toner cost are biddable parameters, and “pages per yr avg” is a constant.

### EXAMPLE B

FIG. 20B illustrates a total cost formula for an example sub-category, Tires. In this example, total cost is driven by price and tread life (miles usage per tire) The total cost calculation is: (Total Miles/Tread Life*Price), where Tread Life and Price are biddable parameters, and Total Miles is a constant (the purchaser's total expected tire usage in miles).

### EXAMPLE C

FIG. 20C illustrates a total cost formula for Telemarketing Services. In this example, total cost is driven by price, volume discounts at two tier levels ($5M and $10M) and training costs. The total cost may be calculated under two scenarios. If volume is concentrated with fewer suppliers, the total cost will reflect the volume discounts at $10M. If a larger number of suppliers is included in the award, the total cost will reflect the volume discounts at $5M. Whichever scenario the purchaser wishes to test, the total cost calculation will be adjusted as follows: For the $10M discount scenario, the total cost calculation is: Price+(−volume discount at $10M*Price)+(Training cost per hour*training hours/total hours), where Price, “volume discount at $10M” and “Training Cost per hour” are biddable parameters, and “training hours” and “total hours” are constants. For the $5M discount scenario, the total cost calculation is: Price+(−volume discount at $5M*Price)+(Training cost per hour*training hours/total hours), where Price, “volume discount at $5M” and “Training Cost per hour” are biddable parameters, and “training hours” and “total hours” are constants.

Assigning Reports

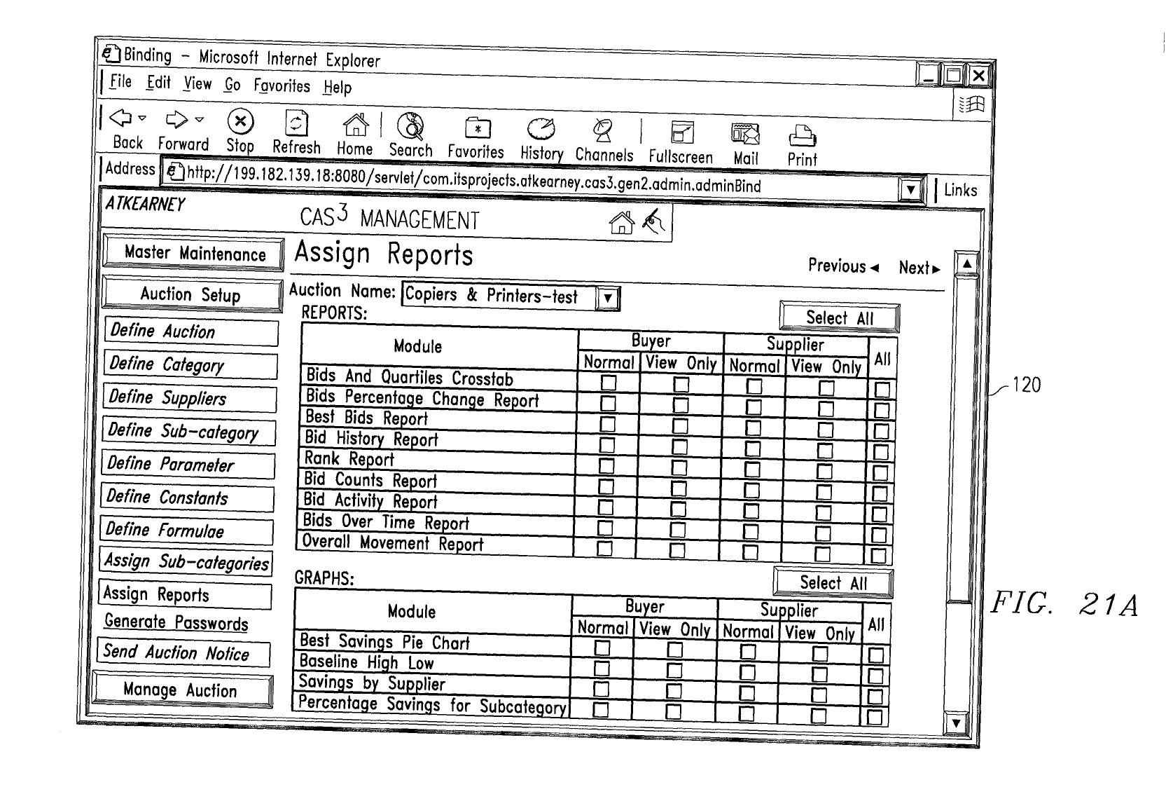

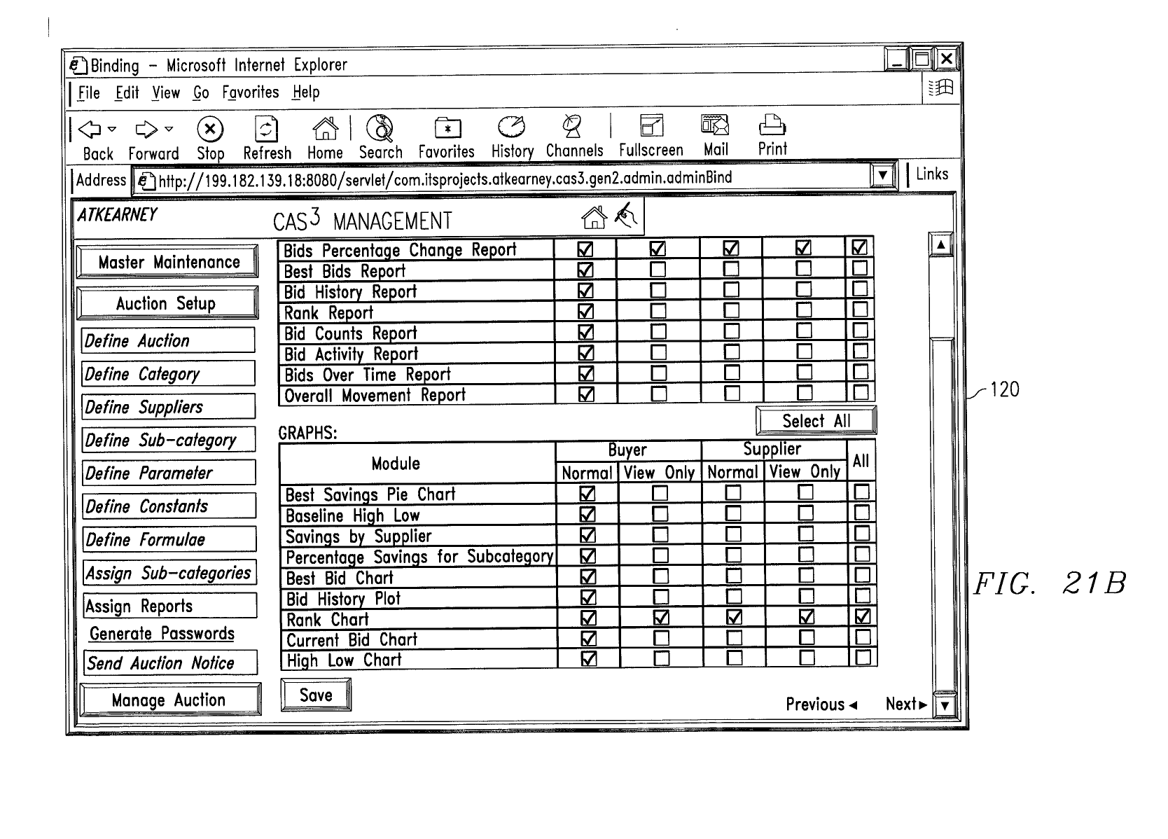

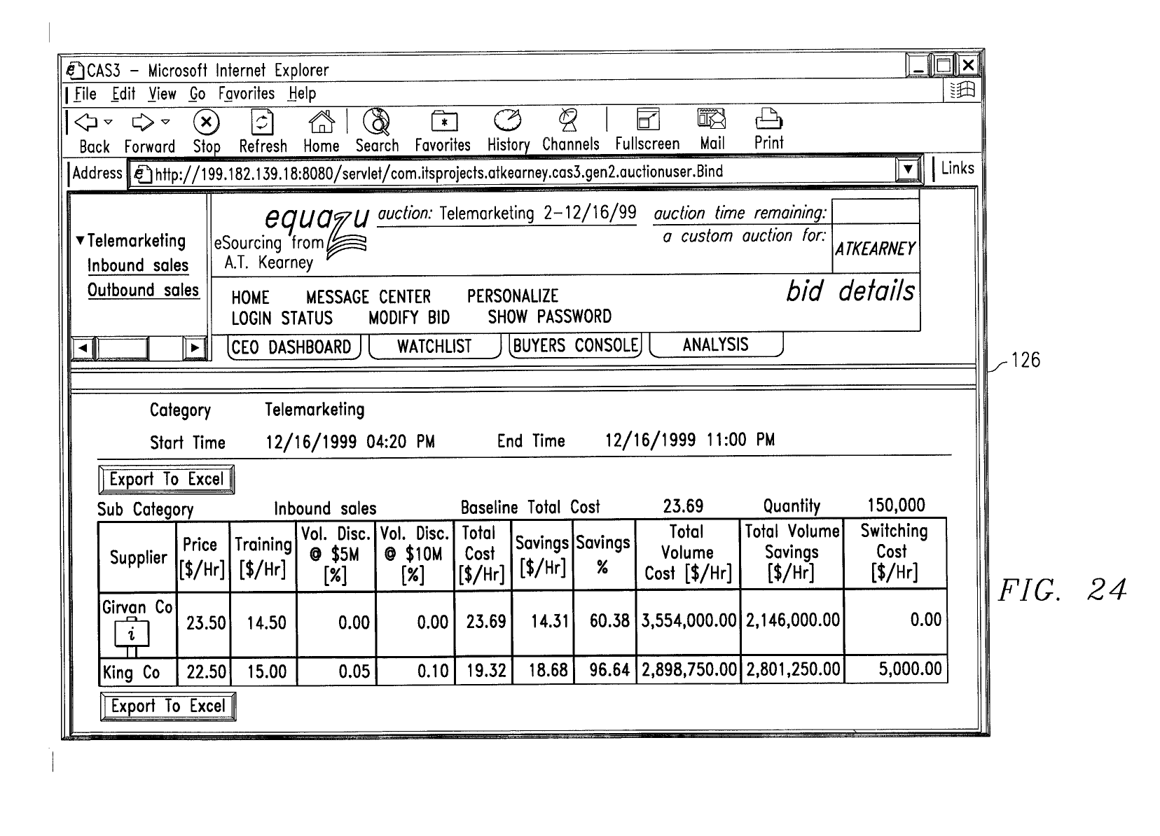

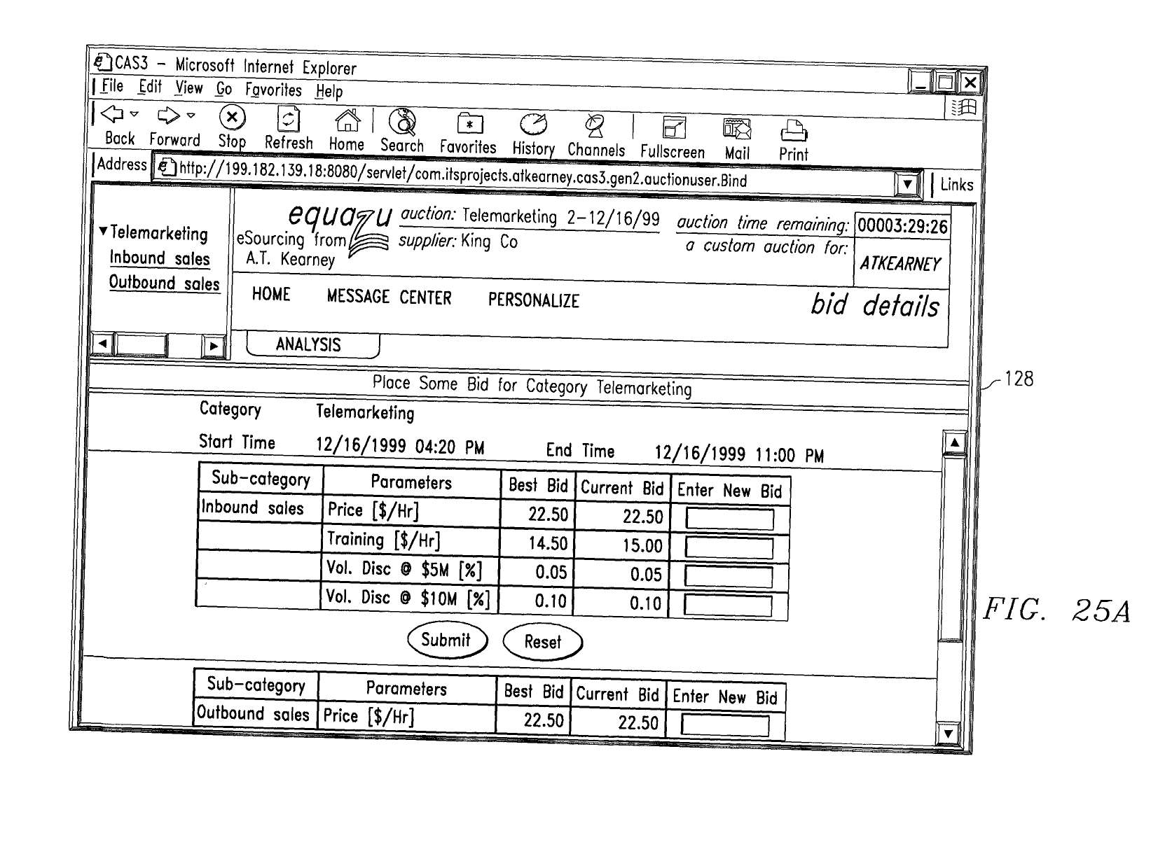

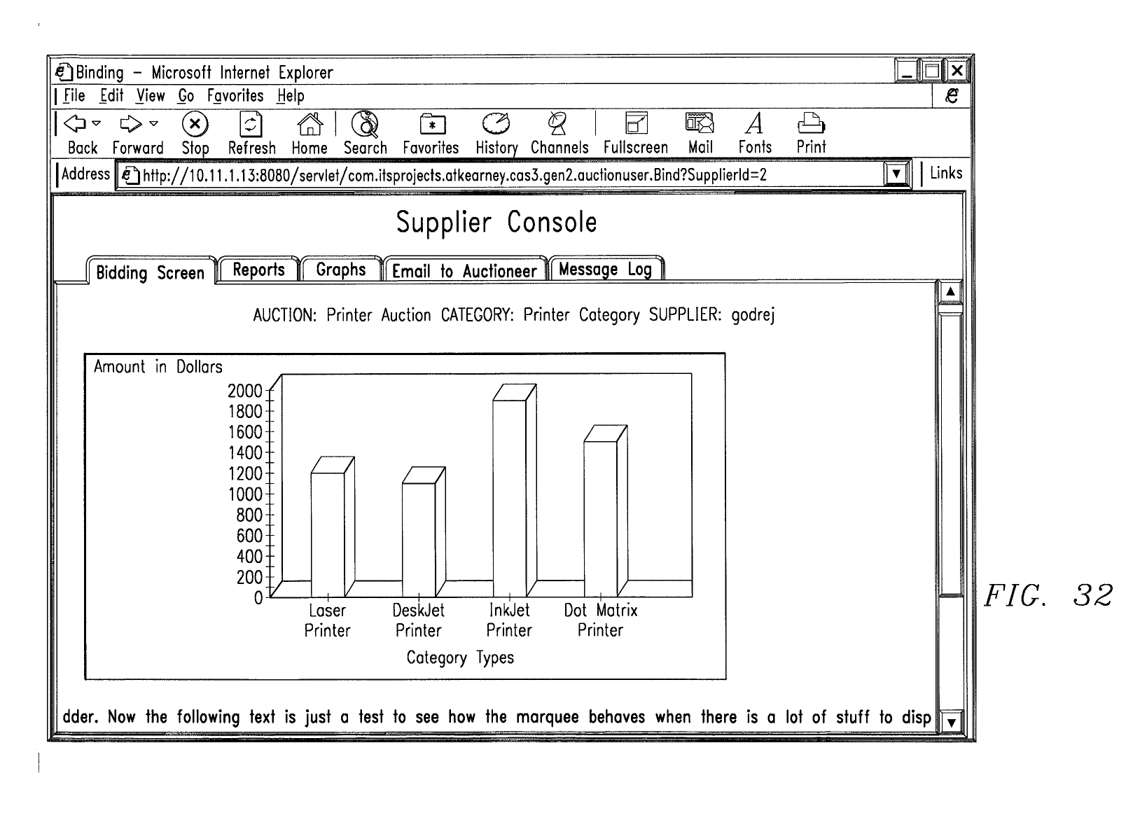

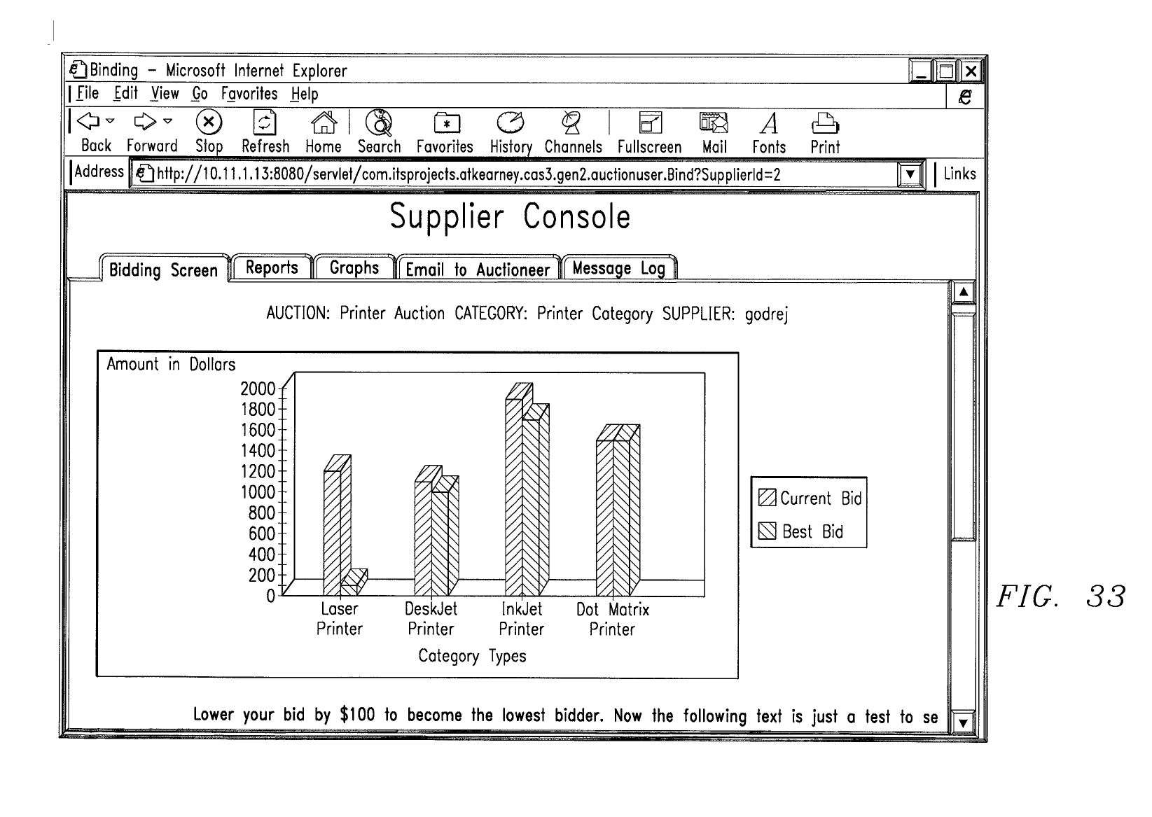

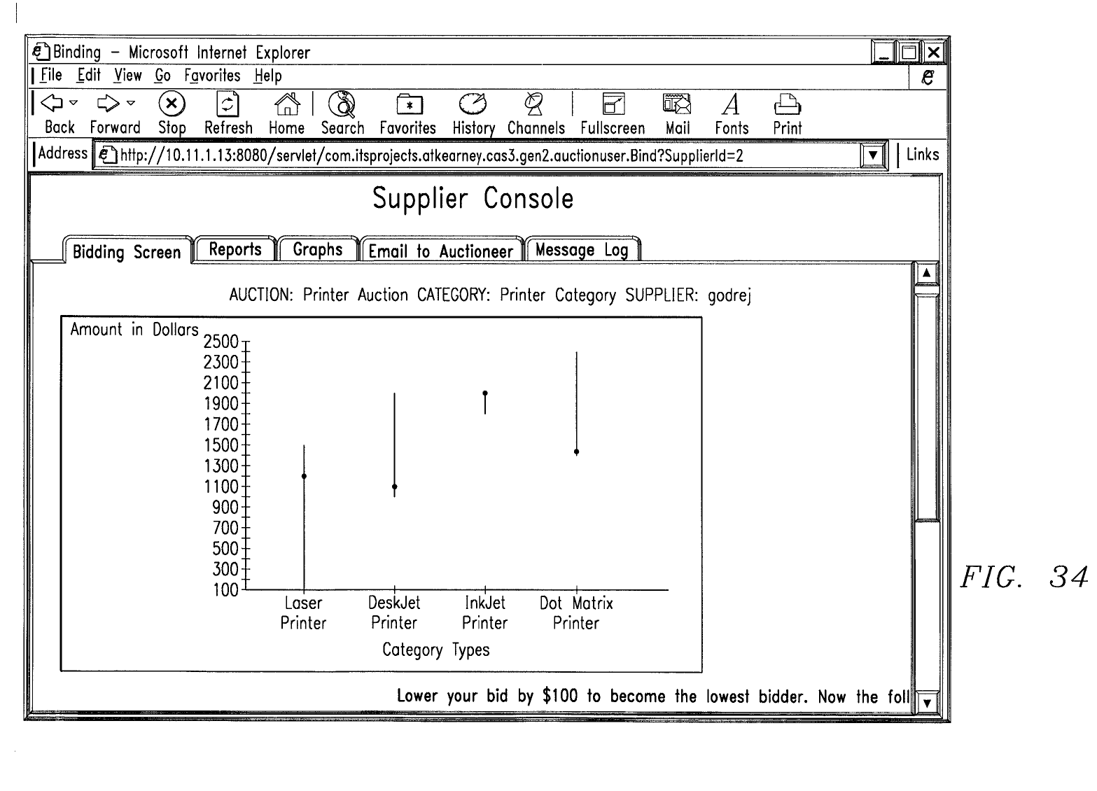

Referring now to FIGS. 21A and 21B, the system may include a report selection interface 120 to assign a set of reports that will be viewable by the vendors during the auction, as well as the set of reports that will be viewable by the purchaser during the auction. FIGS. 32-35 illustrate examples of the types of graphs and reports the system may be adapted to provide to pre-selected users. FIG. 32 provides a vendor bids bar graph displaying the vendors' own bids for each category. FIG. 33 provides a low bids bar graph displaying both the vendors own bids and the lowest bid for each category. FIG. 34 provides a stock graph of the entire range of bids from the highest to the lowest bids and marks the lowest bid. FIG. 25 displays the vendors' position by subcategory. It should be appreciated that the system could be adapted to provide other graphs and other useful information to the vendor. Where desired, some of these reports may be suppressed by the purchaser.

Generating Auction Summary and Password

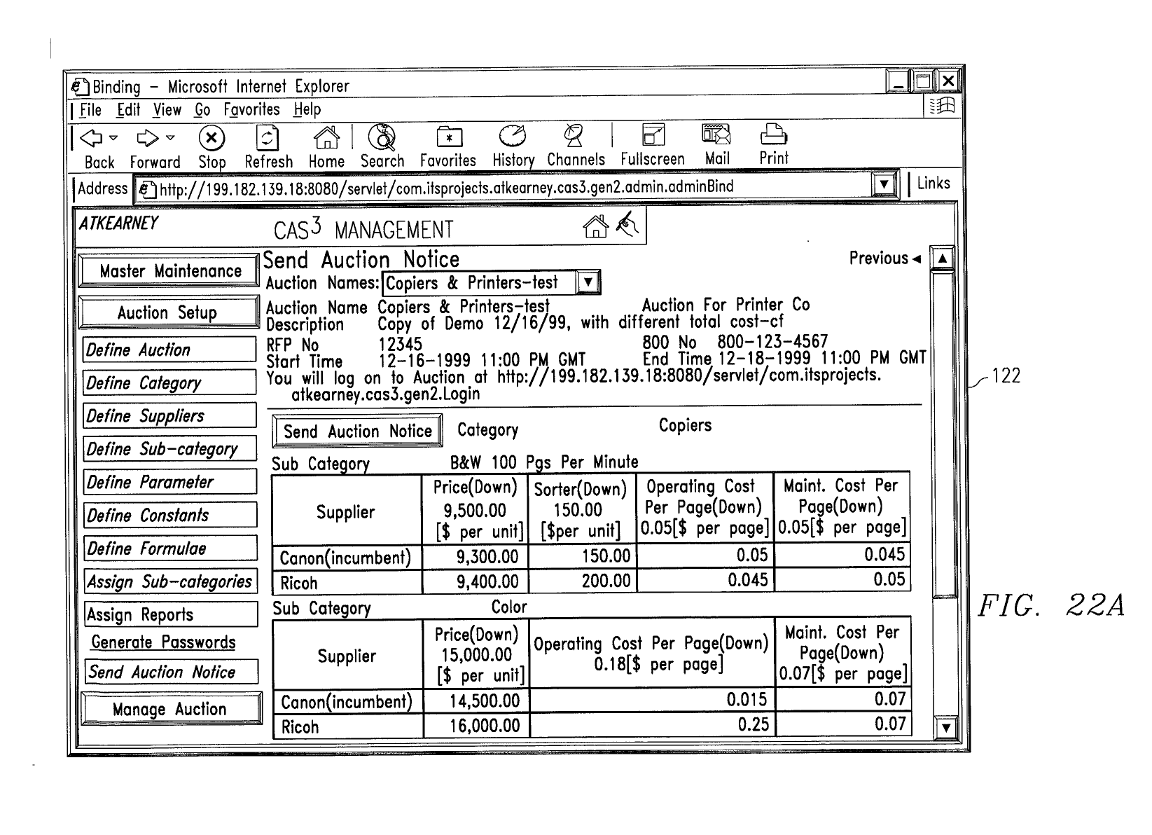

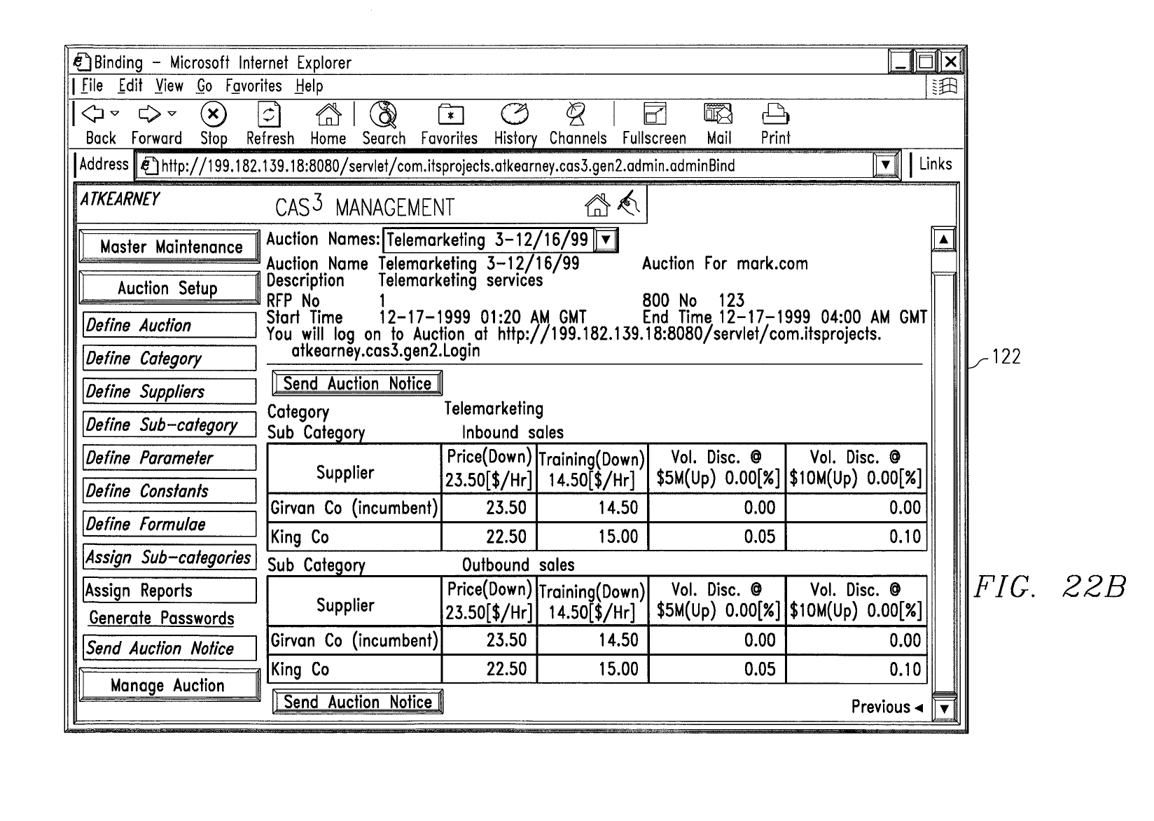

Referring now to FIGS. 22A and 22B, the system may include an auction verification and notification interface 122 the system provides to the auctioneer or implementor at the end of the auction setup. This interface is preferably the last interface displayed in the auction setup mode, enabling the implementor to view a summary of the auction. The implementor can make modifications to the auction by returning to the corresponding pages using the navigation links or buttons provided on the interface 122 as discussed above.

Interface 122 also enables the implementor to print or send auction information. If the auction setup is complete, the implementor can print out a hardcopy of the auction setup. Additionally, the implementor can transmit auction notifications to the participating purchaser and vendors automatically via email by clicking the “Send Auction Notice” button. The auction notification provides the participants with such information as date, start and end time of the auction. This feature also provides the vendors and purchasers with a user name and password required to access the auction. The users also receive a “View Only” password, so that remote team members may view the auction, without the ability submit bids.

Auction Management

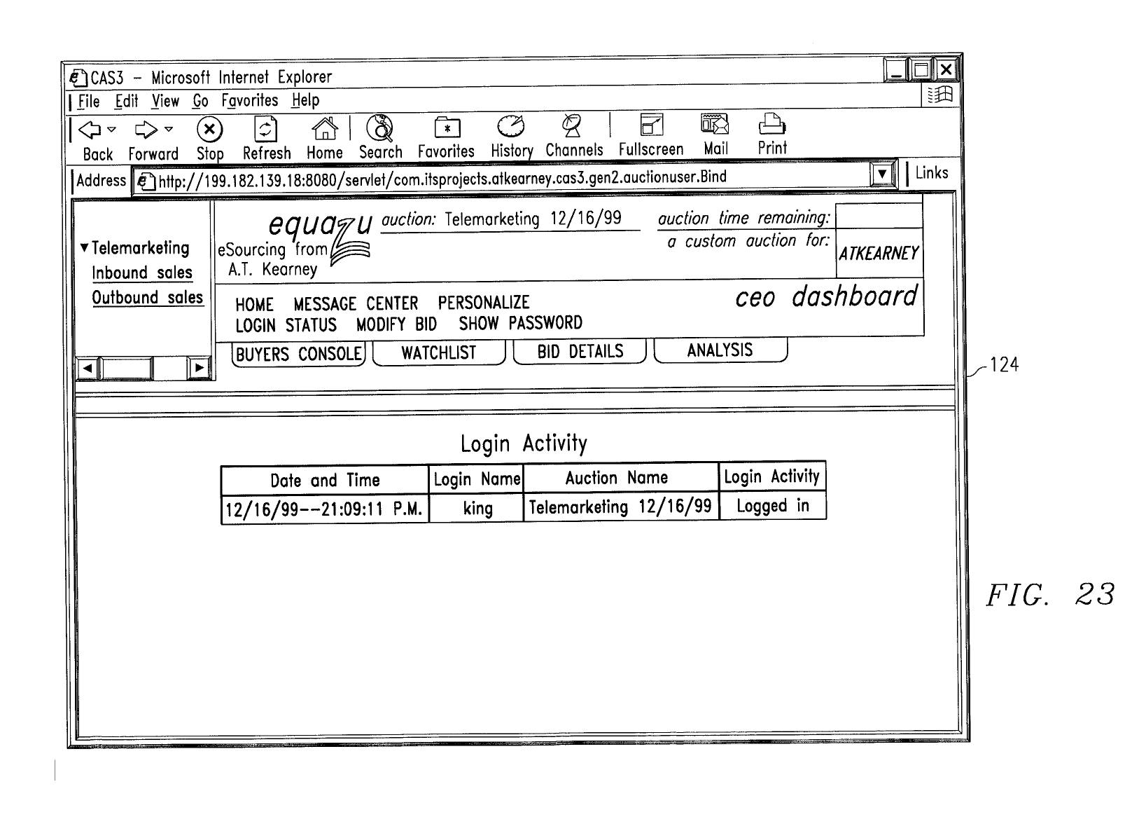

The system enables the implementor to monitor and manage the auctions, end an auction and send or broadcast messages to the purchaser or vendors using an online messaging feature provided by the system. Turning now to FIGS. 23 and 23A, the system may provide an auction management interface 124 which enables the implementor to select a specific auction for monitoring and to view specific details of that auction. The interface 124 in FIG. 23 displays the category and subcategory for the specified auction (i.e., printers and printer cartridges) and shows the current login activity for the auction. The auction management interface also allows the implementor to view the high level purchaser interface 130, the bid information interface 126, the total cost formula display interface 125 illustrated in FIG. 23A, the analysis section which shows selected reports, and the top supplier monitoring interface 132, which are each described in the purchaser interface section below.

Although not shown in FIG. 23, the interface 124 may enable the implementor to change or modify erroneous bids as requested by the vendors and approved by the purchaser. The system may also enable the implementor: (i) to send email or screen messages to one or more purchasers or vendors using the electronic mail device and view a log of all messages sent; (ii) view vendor and purchaser passwords and logon ID's; or (iii) forcibly end the auction if desired. The system sends appropriate messages and sounds to all the vendors and the purchaser at the beginning and prior to end of auction. The system may also enable the implementor to transfer HTML data from vendor bidding into a worksheet for carrying out calculations and analysis using this interface. Although this embodiment uses HTML data, any type of data could be used without departing from the scope of the invention.

System 10 may transmit messages for various scenarios using an electronic mail device in communication with a central auction management system. Such messages can be broken down into two categories: (i) user specific messages; and (ii) general messages, and can be further classified as automatic and manual messages. Examples of user specific messages include an alert message to a vendor suggesting the best bid, a message indicating that a bid is not within a range defined in the auction set-up or too low; or a message that the vendor is inactive and should participate and bid actively. General messages include, but are not necessarily limited to, broadcasting auction time extensions, auction end time countdowns, etc.

Vendor Interface

Turning now to FIGS. 25A and 25B, the system may provide a vendor accessible interface 128 which displays relevant information enabling the vendor to participate in the auction. This interface 128 enables the vendors to place bids on the various parameters for different subcategories in each category. The interface displays the vendor's current bid enables the vendor to view the best bid submitted by another unidentified vendor for each of the parameters. Viewing of the best bid may be suppressed, where desired.

Interface 128 includes a ticker at the bottom of the interface for displaying messages to the vendor and providing useful information to the vendor during the auction. The vendor specific and general messages to the vendor regarding the auction including alert messages to the vendor suggesting the best bid, messages indicating that the vendor's bid is not within a specified range, auction time extensions and auction end time countdowns. The interface may also include a clock that adjusts to the bidder's time zone, that flashes red ten minutes before the auction end time. Interface 128 also includes multiple links that enable the vendor to jump among related vendor interfaces to view bidding information, view reports and graphs, transmit and receive e-mail messages, and view a message log. FIG. 25 discussed above provides an illustration of the bidding interface accessed through the bidding screen link. The e-mail to implementor link enables the vendor to communicate with the implementor using the electronic mail device (i.e., send and receive emails). The message log link enables the vendor to view a log of messages transmitted during the auction. The analysis section of the vendor interface allows the vendor to select and view pre-selected real-time graphs and reports, examples of which were described previously in FIGS. 32-35.

Purchaser Interface

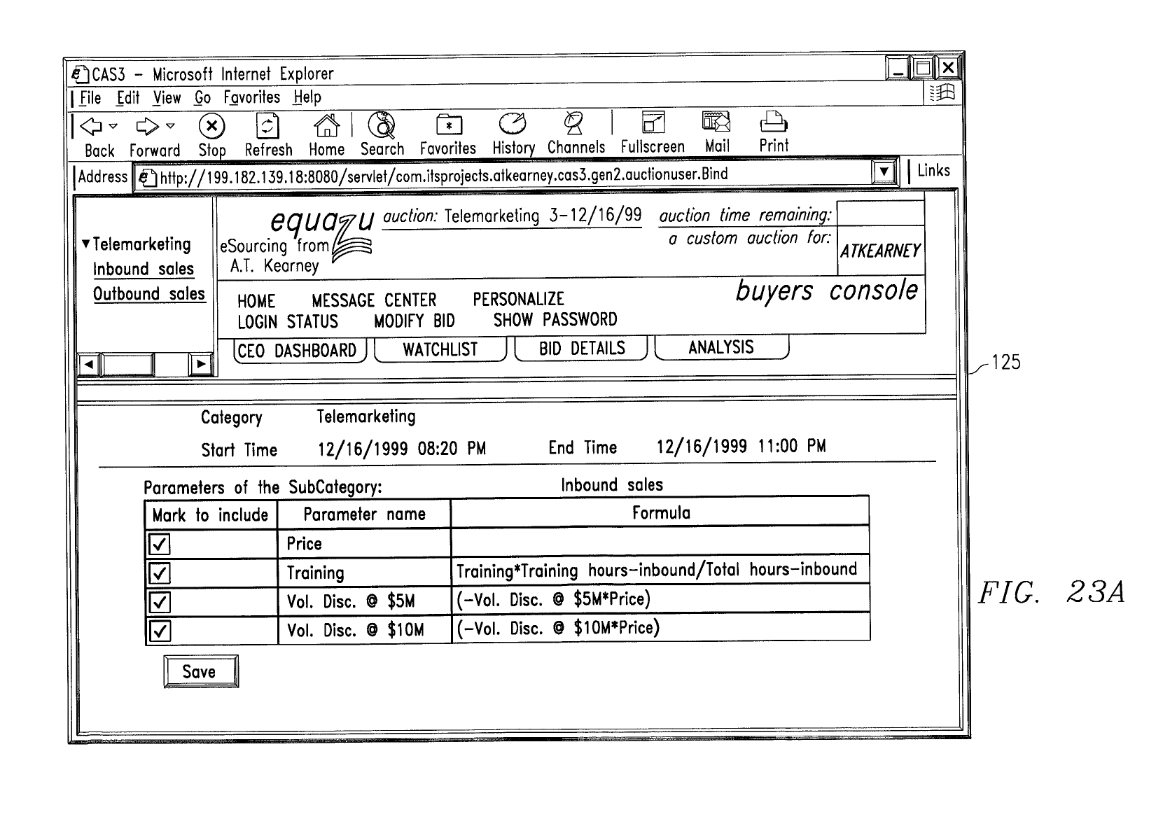

Turning now to FIG. 24, the system may include an activity viewing interface 126 accessible by the purchaser and implementor through the auction management interface 114. Interface 126 displays specific information on a selected auction preferably including the total costs, savings and savings percentage. For the selected auction (i.e., printer auction) shown in FIG. 24, interface 126 also provides the implementor with auction information on all the vendors participating in the auction and parameters in the selected category. The system also indicates the current best comparable total cost by displaying a low icon and a new bid by displaying a new icon.

Turning now to FIG. 26, the system may provide a purchaser accessible interface 130 which enables the purchaser to view high-level bid information, view total savings by supplier and make total cost adjustments by supplier to test different scenarios. Interface 130 also includes multiple links that enable the purchaser to view other interfaces to obtain the general bidding information, bidding information of specific vendors, bid details, reports and graphs, transmit and receive e-mail messages, and view a message log.

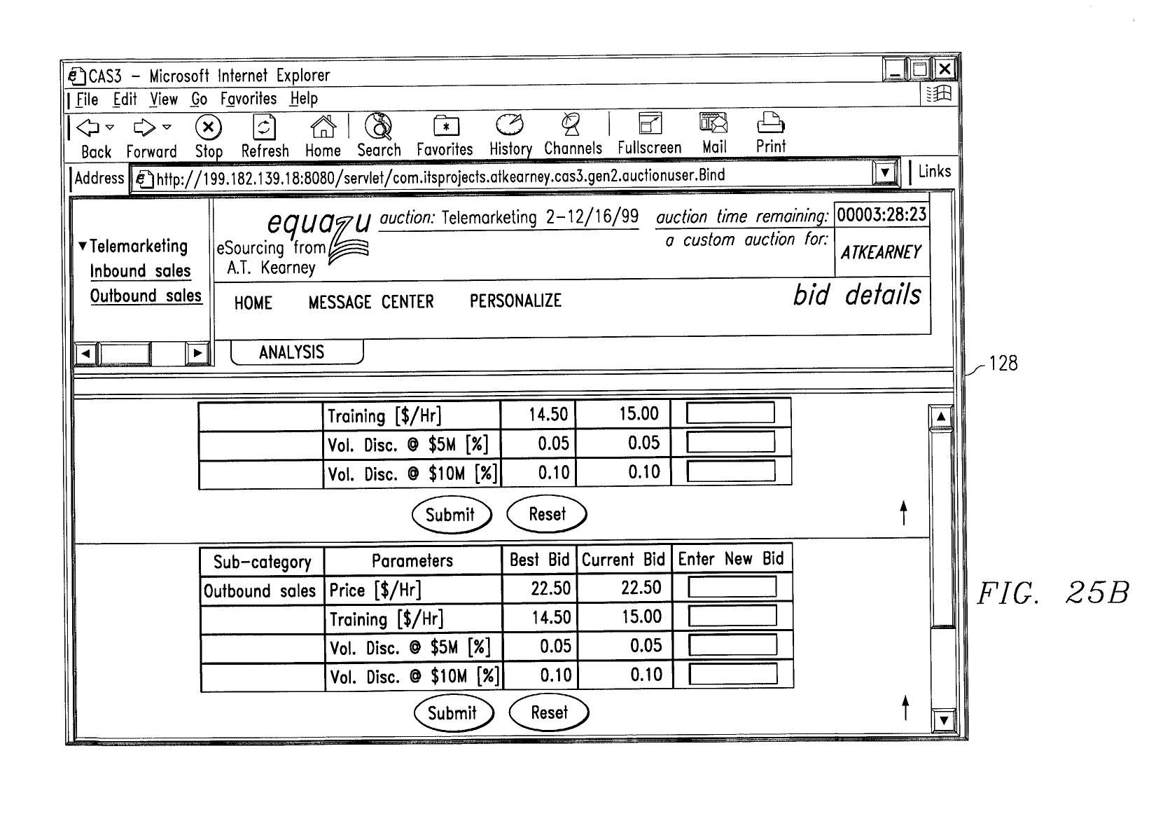

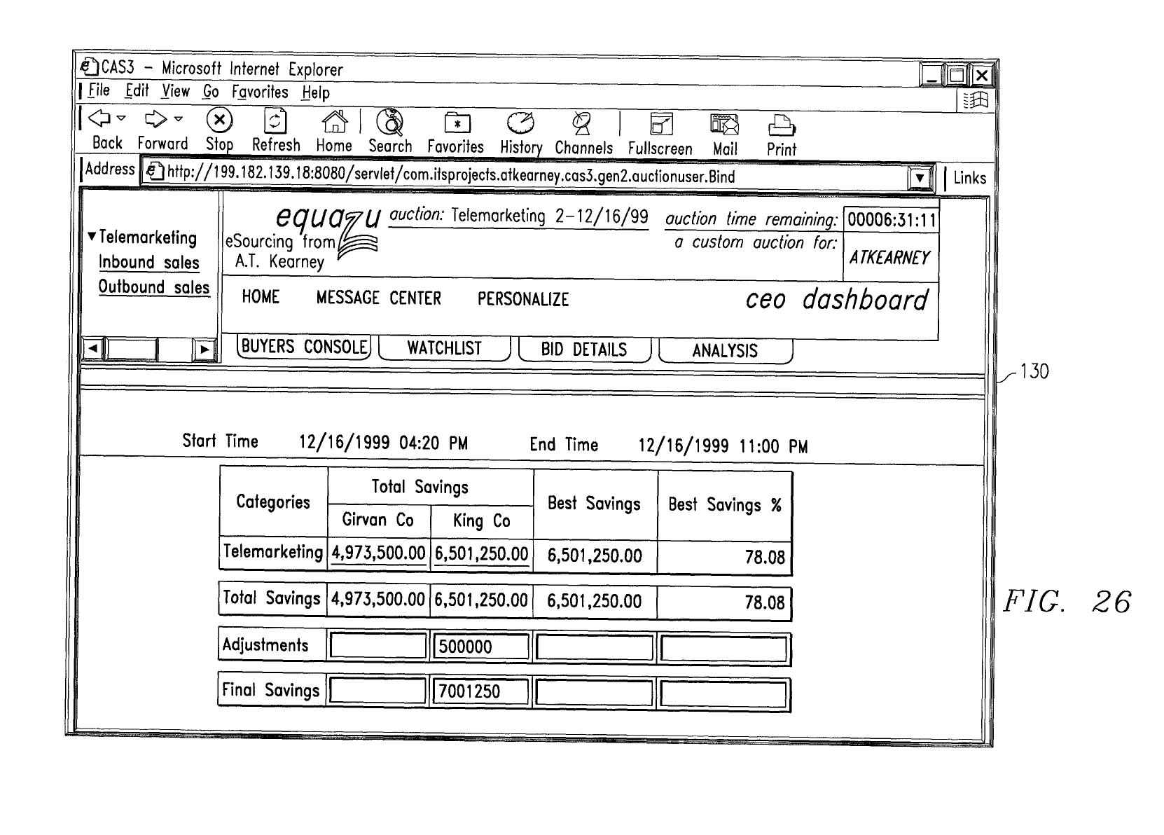

In FIG. 27 another illustration of a purchaser accessible interface 132 is provided and is accessed by selecting the “Watch List” link. This interface 132 enables the purchaser to view bids entered by the top five vendors on the various parameters (e.g., the largest vendor in a particular industry and the closest competition) Selecting the bid details link enables the purchaser to view in-depth details on a specific vendor bid. The e-mail to implementor link enables the purchaser to communicate with the implementor using the electronic mail device (i.e., send and receive e-mails). The message log link enables the purchaser to view a log of messages communicated during the auction. There are also links to access pre-selected reports and graphs, as described previously in FIGS. 28-31.

The system described herein provides only one example of a system that can be used to implement the present invention. Various features described above may be omitted or other features included without departing from the scope of the invention.

General System Structure

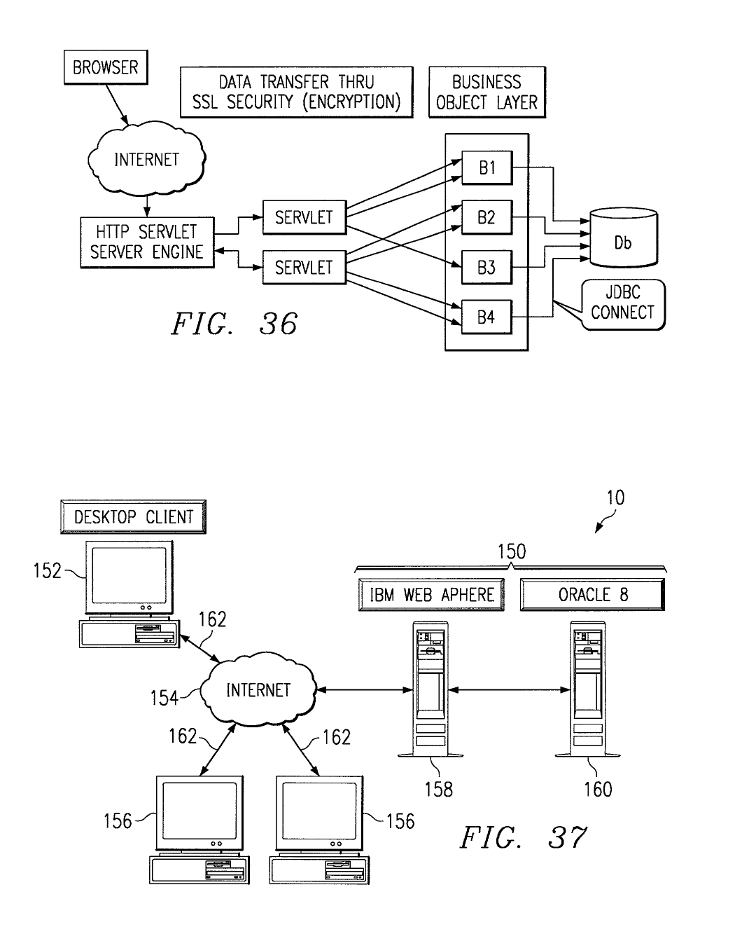

Referring now to FIGS. 36 and 37, system 10 includes a central auction management system (“CAMS”), generally designated 150, comprising two central servers which host a web application and the system database. The implementor uses an implementor computer (not shown) to communicate with the CAMS 150. The purchaser uses at least one purchaser computer 152 (which may be remotely located) to communicate with the CAMS 150 (via the internet 154 or other suitable communication methods) to access the auction, view the bidding process in real-time and make adjustments as described above. The vendors each use at least one vendor computer 156 (a plurality of vendors use a plurality of remote computers 156 each of which may be remote) to communicate with the CAMS (via the internet or other suitable communication methods) to enable each of the vendors to transmit bids for the products and to obtain the information on the best total cost submitted by the other vendors participating in the auction. After each vendor transmits a bid, the CAMS 150 determines the total cost for the vendor using the pre-defined cost formula and enables the implementor and the purchaser to view the vendors' bids.

Communication between the purchaser, vendors and implementor and the CAMS 150 in this embodiment is facilitated via the Internet but could be facilitated using any other suitable communications network 154. (Alternatively, communications may occur using other communications techniques and the relevant data may be manually entered into the CAMS 150 by the purchaser and/or implementor.) Furthermore, while only three remote computers are shown, it should be appreciated that the system 10 can be used by more or less users and in particular at least one purchaser and a plurality of vendors. CAMS 150 may be a Sun Microsystem® or other suitable hardware platform able to support a database server and a web application server. Any other computer may be used, however, without departing from the scope of the invention. In addition, a web server need not be used and the application could be implemented using another type of server without departing from the scope of the invention.

In one embodiment, CAMS 150 includes an auction manager and electronic mail devices, but these may be omitted without departing from the scope of the invention. CAMS 150 includes at least one web application server 158 such as an IBM Websphere or other suitable server. Web server 158 may act as the electronic mail device providing communication between the system 10, and the implementor, purchaser and vendors; in addition to securing the system, providing the system 10 with user authentication, secure socket layer (SSL), CGI Scripting, and encryption. Further, the software that generates the screen interfaces may run on the web server 158. Where a web server is not used, other suitable software may perform these and other functions. In addition, some of these functions may be omitted.

CAMS 150 may includes at least one storage medium. In the embodiment depicted, database server 158 includes the storage medium and the master database files and is depicted in FIG. 37 as an Oracle® 8 database server, although other storage mediums could be used. Using a database server provides for database access and security. CAMS 150 may itself be stored on a computer readable storage medium such as a hard disk drive, floppy disk drive, optical disk drive, random access memory, read only memory, a tape drive, of any other storage medium capable of storing computer software.

CAMS 150 may also include an auction manager device that enables the implementor to manage the auction. In one embodiment, the auction management device is an auction engine comprised of a collection of daemon processes operating on the database server 158. These processes monitor the status of all the auctions in the system 10 and start, stop or extend the auctions. The auction engine periodically (for example, once every 60 seconds) checks to see: (i) If any auction category needs to be started and sends an “auction will start message” to all logged in appropriate purchasers and vendors; (ii) if any auction category needs to be started immediately and sends an auction has started message to all such purchasers and vendors; (iii) if any auction category needs to be ended in the next five minutes and sends an auction will end message to all such purchasers and vendors; (iv) if any auction category needs to be ended and sends an auction has ended message to all such purchasers and vendors; and (v) if any auction category needs to be extended and sends an auction has been extended message to all such purchasers and vendors.

This auction engine also periodically (for example once every 10 minutes) checks to see if there are any auctions that ended recently for which auction reports have not yet been generated. For all such auctions, it generates auction reports and transmits them to the appropriate purchasers and vendors.

FIG. 37 further reveals the remote purchaser computer 152 operably connected to the data network 154, which enables the purchaser to interact with the sourcing system 10 of the present invention. While only one remote computer 152 is shown, more than one computer is contemplated allowing multiple employees of the purchaser to interact with the system 10 and view the on-line bidding process at the same time. While many types of remote computers are contemplated, in one embodiment, the remote computer 152 includes a personal computer running a World Wide Web browser. It is contemplated that the system 10 will not limit the purchaser to one auction, but will enable the purchaser to conduct concurrent on-line bidding or auctions running on multiple browser sessions.

Further, the purchaser's remote computer 152 may include an input/output device, such as a printer, etc., connected thereto and is operably connected to the telephone/data network 154 via a suitable device. Other I/O devices could be utilized to transfer data between the CAMS 150 and the plurality of remote computers. Further, the remote computer 152 is operably connected to the data network 154 by a connecting device 162 which could include telephone wires, optical fibers, cellular communications, etc.

Two vendor remote computers 156 are shown in FIG. 37 operably connected to the CAMS 150, which enables the vendors to interact with the sourcing system 10. As provided earlier, while two remote computers 156 are shown, more than two computers 156 corresponding to a plurality of vendors are contemplated, allowing multiple vendors to interact with the system 10 and participate in the auction at the same time. While many types of remote computers are contemplated, in one embodiment, the remote computer 152 comprises a personal computer running a World Wide Web browser. Each of the plurality of remote computers 156 may include an I/O device, such as a printer, etc., connected thereto and are operably connected to the telephone/data network 154 via a suitable device. Other I/O devices could be utilized to transfer data between the CAMS 150 and the plurality of remote computers. Further, like the remote computer 152, remote computer 156 is operably connected to the data network 154 by a connecting device 162 which could include telephone wires, optical fibers, cellular communications, etc.

Turning now to FIG. 36, a schematic depicting an example system architecture of one embodiment of the present invention is shown. The system 10 may be portable, robust, flexible, scalable and secure to handle. In this embodiment, the system 10 builds on an open multi-tiered architecture, using Java® technologies such as servlets, applets and Enterprise JavaBeans®.

The multi-tiered architecture lends itself naturally to the portability and scalability requirements and is developed and deployed using a middle-tiered application server from IBM® (IBM Websphere). In one embodiment, tier 1 (Presentation tier) displays data and performs user interactions using a web browser 164 operably associated with the data network 154 utilizing JavaScript and Java applets; tier 2 (Presentation Services tier) prepares data for specific presentation formats using an HTTP Servlet server engine 166 operably associated with the data network 154 and a plurality of Java servlets 168 to create HTML pages for the browsers 164. The servlets 168 use business objects 170 to obtain the data to be displayed. Tier 3 (Business Logic tier) processes the business-logic and requests storage and retrieval of data. The business objects 170 are a collection of objects that represent the business intelligence of the system 10 (e.g., auction, category, purchaser, vendor, parameter, bid, etc). The business object layer is specifically scalable as these objects can be distributed across physically separate machines running on their own CPU and memory space, thus enhancing performance. Tier 4 (Data Services tier) performs physical storage and retrieval of data in a master database file using the database server 160.

The business object layer further creates discreet database objects. These discrete database objects can be used with external systems to enhance sourcing performance. For example, the discreet database objects can be exported to an external purchaser contracting system for generating contracts and purchase orders. Although the illustrated architecture is one possible architecture, others can be used without departing from the scope of the invention.

In operation, CAMS 150 accepts data reflecting multiple parameters associated with a product or group of products. CAMS 150 may be used to collect data desirable for an on-line auction. It may then enable the auction as of a specific time and optionally provide notification that the auction has begun. Vendors may bid on a product or group of products using some or all of the above referenced features. Bidding may include multiple parameters associated with a product or category of products. The auction status may or may not be viewable in real time by vendors and/or purchasers. CAMS 150 may be used to manually or automatically send messages to vendors during the auction to increase competitive bidding during the auction. A purchaser may also change the formula used to weight certain parameters to calculate a total cost while an auction is ongoing to test various scenarios. Reports may be generated during or at the conclusion of an auction. For purposes of this application, multiple parameters are considered to be associated with a product even where such multiple parameters are associated with a category or subcategory of products.

Although the present invention has been described in detail, it should be understood that various changes, substitutions, and alterations can be made hereto without departing from the spirit and scope of the invention as defined by the appended claims.

To aid the Patent Office, and any readers of any patent issued on this application in interpreting the claims appended hereto, applicants wish to note that they do not intend any of the appended claims to invoke paragraph six of 35 U.S.C. §112 as it exists on the date of filing hereof unless “means for” or “step for” are used in the particular claim.

What is claimed is:

1. An electronic bidding system, comprising:
means for enabling each of a plurality of vendors to submit bids on at least two parameters associated with a product;
means for calculating the total cost of the product to a purchaser for each vendor in response to the vendors bids, the total cost taking into account the at least two parameters associated with the product; and
means for outputting each of the vendors bids and the total cost of the product to the purchaser.

2. The bidding system of claim 1, wherein the bids include a plurality of parameters for the product and the total cost calculating means determines the total cost of the product to the purchaser using a pre-determined total cost formula.

3. The bidding system of claim 2, wherein the total cost formula includes at least one pre-defined constant.

4. The bidding system of claim 1, further comprising:
means for communicating a vendor bid having the best total cost for the product to the vendors without revealing the identification of the vendor with the best total cost to encourage competitive bidding by the other vendors.

5. The bidding system of claim 1, further comprising:
means for enabling the purchaser to make at least one adjustment corresponding to at least one of the vendor bids which is used by the calculating means to determine the total cost of the product to the purchaser.

6. The bidding system of claim 1, further comprising:
means for enabling communication with the vendors during the bidding.

7. The bidding system of claim 6, wherein said communication means enables messages to be sent to the vendors to encourage further bidding by the vendors.

8. The bidding system of claim 7, wherein said communication means enables messages to be sent to the vendors regarding the status of the bidding, ending time for the bidding and extensions of the bidding.

9. The bidding system of claim 1, further comprising:
means for calculating the amount of savings for the purchaser and means for communicating the savings to the purchaser.

10. The bidding system of claim 1, further comprising:
means for setting up the bidding on the product.

11. An electronic auction system, comprising:
a computer readable storage medium;
software stored on the computer readable storage medium and operable to receive bids from a plurality of vendors, each bid comprising a plurality of parameters associated with at least one product, calculate the total cost of the at least one product to a purchaser for each vendor in response to the vendors bids, the total cost taking into account the plurality of parameters associated with the at least one product, and output each of the vendors bids and the total cost of the product to the purchaser.

12. The electronic auction system of claim 11, wherein the at least two parameters are selected from the group consisting of price, discount, delivery, installation, training, maintenance, the risks covered by warranty, and length of warranty.

13. The electronic auction system of claim 11, wherein the software is further operable to send data, comprising a vendor bid having the best total cost for the product, to the vendors during the auction without revealing the identification of the vendor with the best total cost.

14. The electronic auction system of claim 11, wherein the software is further operable to send data to the vendors during the bidding to stimulate competitive bidding.

15. The electronic auction system of claim 11, wherein the software is further operable to enable the purchaser to make at least one adjustment corresponding to at least one vendor bid which is used by the central auction management system to calculate the total cost of the product to the purchaser.

16. The electronic auction system of claim 11, wherein the total cost calculated for each vendor uses a single formula for all vendors.

17. The electronic auction system of claim 11, wherein the total cost calculated for each vendor uses a plurality of formulas, each vendor having one of the plurality of formulas associated with it.

18. The electronic auction system of claim 11, wherein the plurality of parameters is further associated with a plurality of products.

19. The electronic auction system of claim 11, wherein the auction results take into account vendors bids on a market basket of products.

20. The electronic auction system of claim 11, wherein bids from vendors are received through the Internet.

21. The electronic auction system of claim 11, wherein the software is further operable to provide a vendor with data about the status of an auction while the auction is in progress.

22. The electronic auction system of claim 11, wherein the software is further operable to provide a purchaser with data about the status of an auction while the auction is in progress.

23. The electronic auction system of claim 11, wherein the software is further operable to control which vendors are allowed to participate in an auction.

24. The electronic auction system of claim 11, wherein the software is further operable to allow a total cost formula to be defined for each product in an auction.

25. A method of conducting an on-line auction, comprising:
receiving bids from a plurality of vendors, each bid comprising a plurality of parameters associated with at least one product, calculating, using a computer, the total cost of the at least one product to a purchaser for each vendor in response to the vendors' bids, the total cost taking into account the plurality of parameters associated with the at least one product, and outputting, using the computer, each of the vendors bids and the total cost of the product to the purchaser.

26. The method of claim 25, further comprising:
defining a plurality of parameters for a category of products; and
defining a total cost formula for the category of products in response to the plurality of parameters.

27. The method of claim 26, wherein the total cost formula includes at least one constant associated with at least one parameter.

28. The method of claim 25, wherein the plurality of parameters includes price and non-price parameters.

29. The method of claim 28, wherein the price parameters include at least one of a base price, volume discounts, rebates, life cycle discounts, utilization charges, maintenance charges and administration charges.

30. The method of claim 28, wherein the non-price parameters include at least one of delivery timing, national service coverage, minimum quality levels, employee skill levels, a dedicated account management team, special reporting requirements, online ordering, warranty and length of contract.

31. The method of claim 26, wherein defining a plurality of parameters comprises defining at least two sub-categories for the category of products, and defining at least two parameters for each subcategory.

32. The method of claim 25, further comprising:
communicating the best vendor's bid to the other vendors to encourage competitive bidding.
